(19) United States
(12) Patent Application Publication
(10) Pub. No.: US 2026/0303837 A1
(43) Pub. Date: Oct. 1, 2026

(54) DECODING METHOD AND APPARATUS, CODING METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Xiaozhong XU, Shenzhen (CN)

(21) Appl. No.: 19/694,748

(22) Filed: Jun. 1, 2026

Related U.S. Application Data
(63) Continuation of application No. PCT/CN2025/121293, filed on Sep. 15, 2025.

(30) Foreign Application Priority Data
Oct. 31, 2024 (CN) 202411553018.4

(51) Int. Cl. H04N 19/167; H04N 19/105; H04N 19/172; H04N 19/182

(52) U.S. Cl. CPC H04N 19/167; H04N 19/105; H04N 19/172; H04N 19/182

(57) ABSTRACT

This application provide a coding method. The coding method includes: coding a video frame, to obtain an original bitstream of the video frame; performing predictive coding on each pixel in the video frame to obtain residual information of the pixel, and the residual information of the pixel being configured for representing a difference between original pixel information and prediction information of the pixel; determining, from the video frame, a target pixel whose residual information satisfies a residual condition; identifying a specified region in the video frame according to a position of the target pixel in the video frame, to obtain a detail picture of the video frame; coding the detail picture, to obtain a detail bitstream of the video frame; and transmitting the original bitstream and the detail bitstream of the video frame to a decoder side for joint picture decoding.

### CROSS-REFERENCE TO RELATED APPLICATIONS

This application is a continuation application of PCT Patent Application No. PCT/CN2025/121293, entitled “DECODING METHOD AND APPARATUS, CODING METHOD AND APPARATUS, DEVICE, MEDIUM, AND PROGRAM PRODUCT” filed on Sep. 15, 2025, which claims priority to Chinese Patent Application No. 2024115530184, entitled “DECODING METHOD AND APPARATUS, CODING METHOD AND APPARATUS, DEVICE, MEDIUM, AND PROGRAM PRODUCT” filed with the China National Intellectual Property Administration on Oct. 31, 2024, both of which are incorporated herein by reference in their entirety.

### FIELD OF THE TECHNOLOGY

This application relates to the field of audio and video technologies, especially, to the field of video coding/decoding, and specifically, to a decoding method, a coding method, a decoding apparatus, a coding apparatus, a computer device, a computer-readable storage medium, and a computer program product.

### BACKGROUND OF THE DISCLOSURE

Video coding/decoding refers to a process of coding and decoding a data stream. Coding is to convert the data stream into a compressed format for storage and transmission, and restore a compressed bitstream to an original data format during decoding for playing and processing.

Currently, in a video coding process, a quantization operation is performed on residual information of a video frame. The quantization operation is a lossy operation, and mainly loses some information to make a quantized signal more beneficial to compressed expression. However, due to the quantization operation, a residual signal reconstructed from the compressed bitstream in a video decoding process is different from a difference between an original pixel and a predicted pixel of the video frame. Such difference reduces the quality of a reconstructed pixel during video decoding, resulting in poor video decoding quality.

### SUMMARY

Embodiments of this application provide a decoding method and apparatus, a coding method and apparatus, a device, a medium, and a program product, which can perform detail enhancement on some details in a video frame, to improve prediction accuracy, thereby improving coding/decoding efficiency.

According to an aspect, embodiments of this application provide a coding method. The method includes:
coding a video frame, to obtain an original bitstream of the video frame;
performing predictive coding on each pixel in the video frame to obtain residual information of the pixel, and the residual information of the pixel being configured for representing a difference between original pixel information and prediction information of the pixel;
determining, from the video frame, a target pixel whose residual information satisfies a residual condition;
identifying a specified region in the video frame according to a position of the target pixel in the video frame, to obtain a detail picture of the video frame;
coding the detail picture, to obtain a detail bitstream of the video frame; and
transmitting the original bitstream and the detail bitstream of the video frame to a decoder side for joint picture decoding.

According to another aspect, embodiments of this application provide a computer device. The computer device includes:
a processor, configured to load and execute a computer program; and
a computer-readable storage medium, the computer-readable storage medium having a computer program stored therein, and the computer program, when executed by the processor, implementing the foregoing coding method.

According to another aspect, this application provides a non-transitory computer-readable storage medium. The computer-readable storage medium has a computer program stored therein, and the computer program is suitable for being loaded by a processor to perform the foregoing coding method.

### BRIEF DESCRIPTION OF THE DRAWINGS

FIG. 1 is a schematic diagram of a coding procedure for coding a picture frame by a coder.

FIG. 2 is a schematic diagram of a complete procedure of video coding/decoding.

FIG. 3 is a schematic diagram of an orientation of a reference pixel of a current coding block during intra prediction.

FIG. 4 is a schematic flowchart of a partial detail enhancement solution for frame pictures according to an exemplary embodiment of this application.

FIG. 5 is a schematic architecture diagram of a video coding/decoding system according to an exemplary embodiment of this application.

FIG. 6 is a schematic flowchart of a decoding method according to an exemplary embodiment of this application.

FIG. 7 is a schematic diagram of performing detail enhancement processing on a reconstructed original picture according to a reconstructed detail picture according to an exemplary embodiment of this application.

FIG. 8 is a schematic flowchart of a coding method according to an exemplary embodiment of this application.

FIG. 9 is a schematic diagram of determining a specified region from a video frame according to residual information of pixels according to an exemplary embodiment of this application.

FIG. 10A is a schematic diagram of screening a target pixel from a video frame according to a residual comparison result according to an exemplary embodiment of this application.

FIG. 10B is a schematic flowchart of jointly screening a target pixel based on a luminance value and residual information according to an exemplary embodiment of this application.

FIG. 10C is a schematic flowchart of screening a target pixel in the presence of non-zero residual information around a current pixel according to an exemplary embodiment of this application.

FIG. 10D is a schematic diagram of determining a target pixel based on a difference picture according to an exemplary embodiment of this application.

FIG. 11A is a schematic diagram of identifying a specified region from a video frame according to an exemplary embodiment of this application.

FIG. 11B is another schematic diagram of identifying a specified region from a video frame according to an exemplary embodiment of this application.

FIG. 12 is a schematic structural diagram of a decoding apparatus according to an exemplary embodiment of this application.

FIG. 13 is a schematic structural diagram of a coding apparatus according to an exemplary embodiment of this application.

FIG. 14 is a schematic structural diagram of a computer device according to an exemplary embodiment of this application.

### DESCRIPTION OF EMBODIMENTS

Embodiments of this application provide a coding/decoding solution for a video based on a video coding/decoding technology, specifically including a coding solution and a decoding solution for a video frame in the video. To understand the technical solutions provided in the embodiments of this application more clearly, key terms related to the embodiments of this application are first described herein:

### 1. Video

A video is a file formed by sequentially connecting at least two video frames (or referred to as picture frames). To be specific, the video frame is a smallest or most basic unit of the video. In other words, the video is a dynamic picture including a series of consecutive video frames, and each video frame is a static picture forming the video.

When the video is played, a plurality of video frames are continuously outputted in a temporal order of playing the plurality of video frames. When continuous video frames change more than 24 frames per second, human eyes obtain a smooth and continuous visual effect of the video frames according to a visual persistence principle of human eyes. The video is represented as a video signal, which is usually an electrical signal of the video. Transmission and storage of the video in a network can be implemented by transmitting the video signal of the video. From the perspective of an obtaining manner, the video signal of the video may be photographed by a camera or generated by a computer device. Since statistical properties of different video signals are different, corresponding compressed coding solutions may be different.

### 2. Video Coding/Decoding Technology

A video coding technology refers to a coding manner in which a file in an original video format is converted into a file in another video format by using a compression technology. Specifically, the video coding/decoding technology is implemented based on two processes: a coding technology and a decoding technology, and a decoding process is a reverse process of a coding process. Coding supports converting, by using the compression technology, a video frame into another data format that is convenient for transmission, and aims to reduce a file size, so as to facilitate storage and transmission. Decoding is a reverse process of coding, and supports restoring compressed data to an original format, so as to play the compressed data on a display.

The following describes existing mainstream video coding technologies:

Modern mainstream video coding technologies, represented by international video coding standards such as high efficiency video coding (HEVC), i.e., HEVC/H.265, versatile video coding (VVC), i.e., VVC/H.266, and an audio video coding standard (AVS), adopt a hybrid coding framework to perform the following series of operations and processes on inputted original video signals.

1) Block partition structure: According to the size of an input picture (e.g., a video frame to be compressively coded or decoded in a video), the input picture is partitioned into a number of non-overlapping processing units. Similar compression operations may then be performed on each processing unit during coding and decoding, thereby avoiding difficulties caused by directly coding and decoding a frame of picture. The partitioned processing unit may be referred to as a coding tree unit (CTU) or a largest coding unit (LCU). The processing unit CTU may be further finely partitioned to obtain one or more basic coding units, referred to as coding units (CU) or coding blocks. Each CU serves as the basic element in a coding/decoding process. Subsequent embodiments of this application take each CU as an example for descriptions related to coding and decoding.

2) Predictive coding: Based on the correlation among discrete signals (e.g., spatial correlation between pixels of different parts in the same video frame, or temporal correlation between pixels in different preceding and succeeding video frames), predictive coding uses one or more signals preceding a current signal to predict a predicted value of the current signal, thereby coding a residual (also referred to as a prediction error) between an actual value and the predicted value of the current signal, and avoiding problems such as high computational complexity and waste of compression resources caused by directly compressing all video frames.

Predictive coding mainly includes intra prediction and inter prediction. a. Intra prediction: A prediction signal for a current coding unit is derived from an already coded and reconstructed region within the same picture. b. Inter prediction: A prediction signal for a current coding unit is derived from other coded pictures different from a picture to which the current coding unit belongs (such other pictures may be referred to as reference pictures). During video coding and decoding, when a coder side codes a to-be-coded unit (e.g., the foregoing CU) in an original video signal (e.g., a video frame), if any predictive coding manner (intra prediction or inter prediction) is adopted, a reconstructed video signal from the original video signal is required to predict the to-be-coded unit (if the predictive coding manner is intra prediction, the reconstructed video signal belongs to a current picture, and if the predictive coding manner is inter prediction, the reconstructed video signal is derived from reconstructed pictures preceding the current picture), to obtain a residual video signal (i.e., the foregoing residual) of the current to-be-coded unit. The residual video signal is then compressively coded to generate a bitstream, which is transmitted to a decoder side. Correspondingly, the coder side further needs to notify the decoder side of any predictive coding manner used in the coding process, so that after receiving a coded bitstream (i.e., the foregoing bitstream, or referred to as a picture bitstream, a video bitstream, a compressed bitstream, or the like), the decoder side reconstructs a picture in the decoding process of the coded bitstream by using the same predictive coding manner as that in the coding process.

3) Transform & Quantization: After a residual video signal undergoes a transform operation such as discrete Fourier transform (DFT) or discrete cosine transform (DCT), the signal may be converted into a transform domain, which is referred to as a transform coefficient. In this way, a lossy quantization operation may be further performed on the signal in the transform domain, and some redundant information is lost, so that a quantized signal is beneficial to compressed expression. In some video coding standards, there may be one or more variation manners. Therefore, during video coding and decoding, the coder side needs to select a transform manner for a current CU, and notifies the decoder side of the transform manner, so that the decoder side can perform inverse transform by using the corresponding transform manner in the decoding process. Quantization fineness of the foregoing quantization operation is usually determined by a quantization parameter (QP). A larger QP value indicates that coefficients within a larger value range are quantized to the same output. Therefore, a larger distortion and a lower bit rate (i.e., a number of data bits transmitted per unit time) are usually caused. On the contrary, a relatively small QP value indicates that coefficients in a relatively small value range are quantized into the same output. Therefore, a relatively small distortion and a relatively high bit rate are usually caused.

4) Entropy coding or statistical coding: A quantized transform domain signal is statistically compressed and coded based on statistical coding (i.e., statistically compressed and coded according to a frequency of occurrence of each value), and a binary (0 or 1) compressed bitstream is finally outputted. Meanwhile, other information, such as a selected mode (e.g., prediction mode) and a motion vector, is generated through coding, and entropy coding also needs to be performed to reduce a code rate. The foregoing statistical coding is a lossless coding manner, and can effectively reduce a code rate required for expressing the same signal. The statistical coding may include, but is not limited to, variable length coding (VLC) or content adaptive binary arithmetic coding (CABAC).

5) Loop filtering: A reconstructed decoded picture may be obtained by performing a series of operations such as inverse quantization, inverse transformation, and predictive compensation (i.e., inverse operations of 2) to 4)) based on the picture that has been coded in the foregoing operations. The reconstructed picture has quantization impact compared with the original picture, and some information is different from the original picture. Distortion may be caused. Therefore, it is supported that the filtering operation is performed on the reconstructed picture by using a filter, so that a distortion degree generated by quantization can be effectively reduced. The filter may include, but is not limited to, a deblocking filter (DF), a sample adaptive offset (SAO), an adaptive loop fitter (ALF), or the like. These filtered reconstructed pictures may be used as reference information for subsequent coded pictures to predict a future signal, the foregoing filtering operation is also referred to as loop filtering, namely a filtering operation in a coding loop.

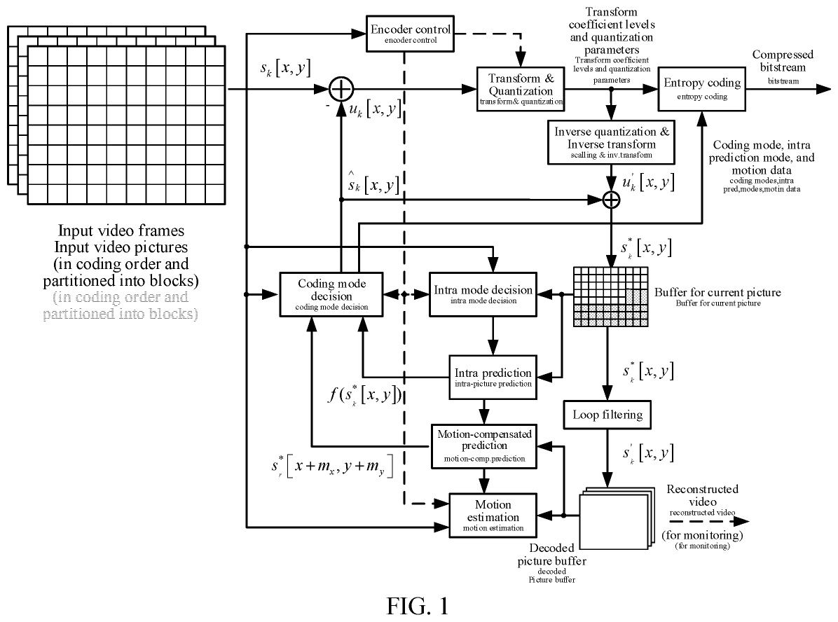

The following describes the foregoing basic procedure (i.e., operations 1) to 5)) of video coding with reference to a video coder shown in FIG. 1. In FIG. 1, illustration is made by taking a current coding block to be coded as a k^{th} CU (sₖ[x, y] as shown in FIG. 1) in a current picture frame, where k is a positive integer, and k is less than or equal to a total quantity of CUs included in the current picture frame. sₖ[x, y] represents a pixel with coordinates [x, y] in the k^{th} CU, x represents a horizontal coordinate of the pixel, and y represents a vertical coordinate of the pixel. A prediction signal ŝₖ[x, y] may be obtained through processing such as motion compensation or intra prediction on sₖ[x, y], and a difference operation is performed between the prediction signal ŝₖ[x, y] and the original signal sₖ[x, y] to obtain a residual video signal uₖ[x, y]. Then, transform and quantization processing is performed on the residual video signal uₖ[x, y] to obtain quantized data. Data outputted through quantization has two data flows:

Data flow 1: A coder side may transmit the data outputted through quantization to an entropy coder for entropy coding, to obtain a coded bitstream, and output the bitstream to a buffer for storage, to wait to be transferred to a decoder side. After the decoder side receives the bitstream, the decoder side may first perform, for each CU, entropy decoding on the bitstream, to obtain various mode information and a quantized transform coefficient of the current CU. Then, inverse quantization and inverse transform are performed on each transform coefficient, to obtain a residual signal. In addition, the decoder side may obtain a prediction signal corresponding to the current CU according to known mode information on the coder side. In this way, the residual signal and the prediction signal are added to obtain a reconstructed signal. Finally, a filtering operation of loop filtering is performed on a reconstructed value (or the reconstructed signal) of a decoded picture, to generate a final output signal.

Data flow 2: The coder may perform inverse quantization and inverse transform processing on the data outputted through quantization to obtain an inverse-transformed residual video signal

$${u}_{k}^{′} [ x , y ] .$$

Then, the inverse-transformed residual video signal

$${u}_{k}^{′} [ x , y ]$$

is added to the prediction signal ŝₖ[x, y] to obtain a new prediction signal

$${s}_{k}^{*} [ x , y ] .$$

The new prediction signal

$${s}_{k}^{*} [ x , y ]$$

is transmitted to and stored in a buffer for a current picture. In this way, the new prediction signal

$${s}_{k}^{*} [ x , y ]$$

may be processed through intra prediction to obtain

$$f ( {s}_{k}^{*} [ x , y ] ) ,$$

and the new prediction signal

$${s}_{k}^{*} [ x , y ]$$

may be processed through loop filtering to obtain a reconstructed signal

$${s}_{k}^{′} [ x , y ] .$$

The reconstructed signal

$${s}_{k}^{′} [ x , y ]$$

is transmitted to and stored in a decoded picture buffer for generating a reconstructed video. The reconstructed signal

$${s}_{k}^{′} [ x , y ]$$

is processed through motion compensation prediction to obtain

$${s}_{r}^{*} [ x + {m}_{x} , y + {m}_{y} ] , where {s}_{r}^{*} [ x + {m}_{x} , y + {m}_{y} ]$$

may represent a reference block, and mx and my respectively represent horizontal and vertical components of a motion vector of the reference block.

As described above, the decoding process is a reverse process of the coding process. Therefore, a process of decoding, by the decoder side, the compressed bitstream after receiving the compressed bitstream coded by the coder side based on the foregoing operations may be described as follows. The decoder side first performs, for each coding block (obtained by the coder side in a block partition manner), entropy decoding after obtaining the compressed bitstream, to obtain mode information, quantized transform coefficients, and the like that are generated in various coding processes. The decoder side then performs, according to the mode information, the transform coefficients, and the like that are obtained through decoding, inverse quantization and inverse transform on the data obtained through entropy decoding, to obtain residual information (or referred to as a residual signal) of a current coding block. In addition, the decoder side predicts the current coding block according to known coding mode information (e.g., information such as a prediction mode used when the coder side codes the current coding block), to obtain prediction information corresponding to the current coding block. In this way, the decoder side may add the residual information and the prediction information of the current coding block, to obtain a reconstructed signal of the current coding block. The reconstructed signals of all coding blocks corresponding to the video frame form a decoded picture of the video frame, where the decoded picture includes reconstructed pixel information (or referred to as a reconstructed value) of each pixel. Then, a loop filtering operation needs to be performed on the reconstructed value of the pixel in the decoded picture, to reduce a distortion degree generated by quantization, so as to obtain a finally restored output signal (i.e., reconstructed picture).

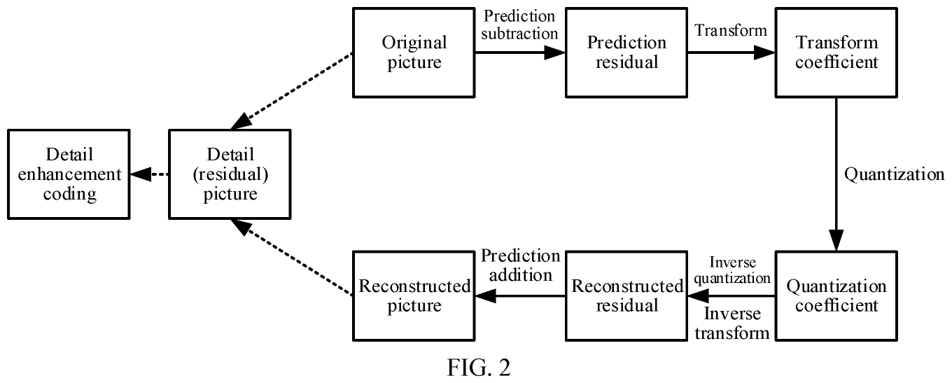

For a complete schematic flowchart of a video coding process and a video decoding process described above, refer to FIG. 2. As shown in FIG. 2, after obtaining a to-be-coded original picture (e.g., a video frame in a video), the coder side performs predictive coding on pixels in the original picture, to obtain prediction information of the pixels in the original picture, and obtains residual information of the pixels by subtracting the prediction information from original pixel information of the pixels. The coder side performs processing such as transform on the residual information, to convert the residual information into a transform domain, to obtain a signal (which may be referred to as a transform coefficient) in the transform domain. Then, a quantization operation is performed on the transform coefficient, to lose some information, so as to obtain a quantization coefficient beneficial to compressed expression. Subsequently, entropy coding is performed on the quantization coefficient, to obtain a compressed bitstream having a binary value (0 or 1). The coder side transmits the compressed bitstream to the decoder side, and the decoder side performs entropy coding on the compressed bitstream, to convert the binary compressed bitstream into a quantization coefficient. The decoder side then performs inverse quantization on the quantization coefficient, to obtain a transform coefficient, and then performs inverse transform on the transform coefficient, to obtain residual information of the current coding block. Meanwhile, the decoder side obtains coding mode information and performs prediction according to the coding mode information to obtain prediction information of the current coding block. In this way, the decoder side predicts information on the residual information of the current coding block, to obtain reconstruction information of the current coding block, and performs the foregoing decoding process on each coding block in the video frame, to obtain the reconstructed picture corresponding to the video frame.

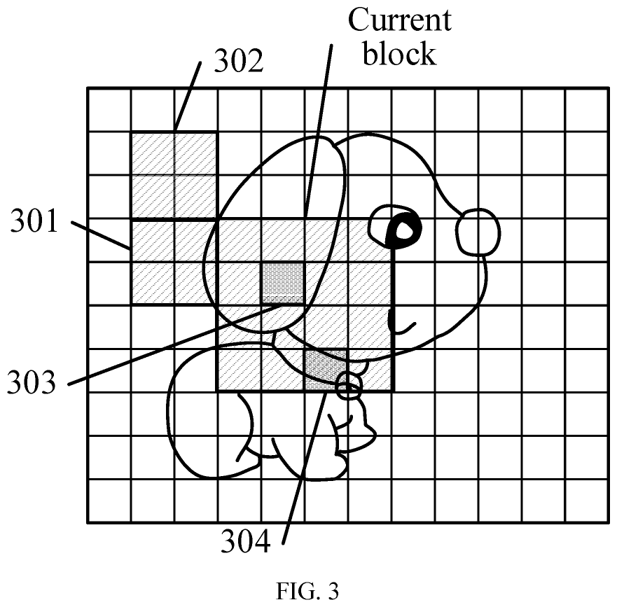

Based on the coding and decoding processes shown in FIG. 2, due to the effects of predictive coding and quantization in the coding process, a difference exists between the reconstructed picture and the original picture, thereby greatly reducing picture quality of a frame of picture. For example, as shown in FIG. 3, a prediction mode used in a coding process is intra prediction. When predictive coding is performed on a current block (e.g., a CU or an LCU), reference pixels of the current coding block are derived from a left region 301 and an upper region 302 of the current coding block in a video frame. Therefore, for a pixel within a left region or an upper region in a current block (i.e., a pixel in the current block relatively close to the left region 301 or the upper region 302), such as pixel 303, since pixel 303 is relatively close to a reference pixel (i.e., a pixel within the left region 301 or the upper region 302), a correlation between the two pixels is relatively strong in a statistical sense. To be specific, pixel information of the reference pixel is relatively strong in reference to pixel information of pixel 303. Then, prediction information of pixel 303 obtained through prediction according to the pixel information of the pixel in the left region 301 and the upper region 302 is relatively accurate, so that residual information generated through prediction for pixel 303 is relatively small. The residual information may be referred to as an absolute value of a residual value, or referred to as a residual absolute value, where the residual absolute value=|actual pixel information−prediction information|.

On the contrary, for a pixel within a right region or a lower region in a current block, such as pixel 304, since pixel 304 is relatively far away from a reference pixel, a correlation between the two pixels is relatively strong in a statistical sense. To be specific, pixel information of the reference pixel is relatively strong in reference to pixel information of pixel 304. Then, prediction information of pixel 304 obtained through prediction according to the pixel information of the pixel in the left region 301 and the upper region 302 is inaccurate, so that residual information generated through prediction for pixel 304 is relatively large. Further, it is considered that when a quantization operation is performed on the residual information of the pixel, larger residual information (e.g., a larger residual absolute value) indicates more information lost during quantization of the residual information, namely a larger precision loss. Therefore, for a current block using an intra prediction mode, when a quantization step is relatively large (a corresponding quantization parameter is large), losses generated due to quantization are not evenly distributed, but the influence on the right and lower regions of the current block is more significant. Therefore, when the decoder side restores the current block, restoring degrees of the pixels within the left and upper regions in the current block are greater than restoring degrees of the pixels within the right and lower regions in the current block. To be specific, details of the right region and the lower region in the current block are to be enhanced.

To reduce a precision loss caused by predictive coding and quantization to some regions in the video frame, the video coding/decoding solution provided in the embodiments of this application is specifically a solution for enhancing details of a frame of picture. This solution can repair a problem such as degradation of picture quality caused by detail loss after video frame compression, thereby improving subjective feelings of users on video decoding quality. For example, this solution supports adjusting and optimizing a prediction residual of a region (e.g., a right or lower region of a current block) by identifying or deducting a prediction residual adjustment value of a to-be-detail-enhanced pixel (e.g., a pixel within the right or lower region of the current block shown in FIG. 3) of the current block using an intra prediction mode, to reduce a prediction residual of an entire block, thereby greatly improving prediction accuracy of intra prediction, and improving coding efficiency.

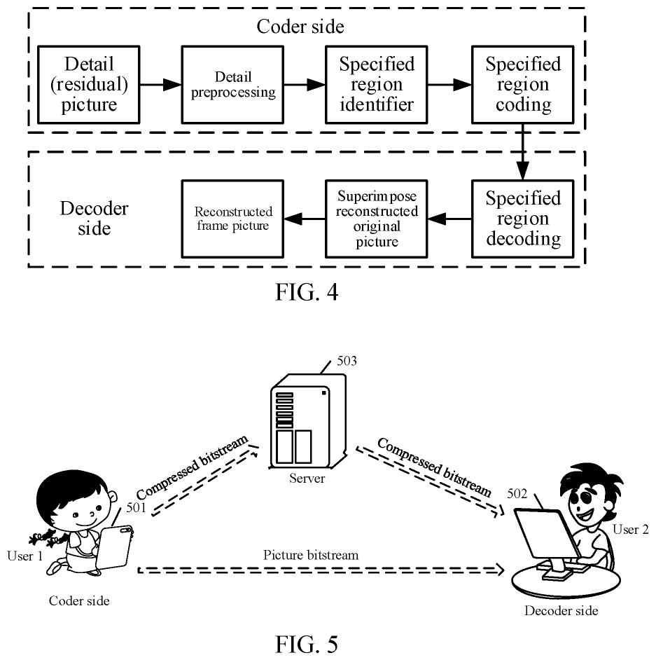

By way of example, for an approximate schematic flowchart of a partial detail enhancement solution for frame pictures according to an embodiment of this application, refer to FIG. 4. As shown in FIG. 4,
at a coder side, a coder obtains a to-be-coded video frame. The coder codes the video frame, specifically including partitioning→predictive coding→transform→quantization→entropy coding, to obtain an original bitstream of the video frame. In addition, in a process of coding the video frame, the coder determines whether detail enhancement needs to be performed on a pixel in the video frame, and identifies, from the video frame, a specified region of the pixel on which detail enhancement needs to be performed, to obtain a detail picture of the video frame. Then, the coder codes the detail picture (in the same manner as the foregoing coding), to obtain a detail bitstream of the video frame. In this way, the coder may package the original bitstream and the detail bitstream into bitstream data, and transmit the bitstream data to a decoder for joint picture decoding.

At a decoder side, the decoder obtains bitstream data of a video frame that needs to be decoded. The bitstream data includes an original bitstream and a detail bitstream of the video frame. The decoder performs picture reconstruction processing (i.e., decoding processing) on the detail bitstream of the video frame, to obtain a reconstructed detail picture of the video frame. The reconstructed detail picture includes reconstructed pixel information of a pixel within a to-be-detail-enhanced specified region in the video frame. In addition, the decoder decodes the original bitstream of the video frame, to obtain a reconstructed original picture of the video frame. Decoding processing is a reverse process of coding processing. In this way, the decoder may perform detail enhancement processing on a specified region in the reconstructed original picture according to the decoded reconstructed detail picture, to obtain a reconstructed frame picture of the video frame.

In view of this, in the embodiments of this application, in a process of coding a video frame, based on conventional coding of the video frame to obtain an original bitstream, a region (i.e., a specified region) in which a pixel having a relatively large information loss in a coding process is located is further identified from the video frame to obtain a detail picture, and the detail picture is also coded to obtain a detail bitstream. In this way, the decoder side may perform, by using the reconstructed detail picture reconstructed based on the detail bitstream, detail enhancement processing on pixels within the specified region in the reconstructed original picture reconstructed based on the original bitstream. The detail enhancement processing herein is intended to adjust or optimize, by using reconstructed pixel information of pixels within a specified region in the reconstructed detail picture, reconstructed pixel information of the corresponding pixels within the specified region in the reconstructed original picture, so that the adjusted or optimized reconstructed pixel information of the pixels within the specified region can more match original pixel information of corresponding pixels in the original video frame, thereby improving video coding/decoding quality and efficiency.

The partial detail enhancement solution for frame pictures provided in the embodiments of this application may be applied to any product having a related video coding/decoding function or video compression function. The product herein may include an application or a computer device.

In some embodiments, if the application is an application having a video coding/decoding function, when the application is deployed with the partial detail enhancement solution for frame pictures provided in the embodiments of this application, all video frames coded and decoded by the application need to be used to implement partial detail enhancement effects. The application may be a computer program that completes one or more particular jobs. The application classified according to running manners of applications may include: a client installed in a terminal, a mini program (as a subprogram of a client) that may be used without downloading and installing, a world wide web (web) application opened by using a browser, and the like. The application classified according to function types of applications may include, but is not limited to, an instant messaging (IM) application, a content interaction application, and the like. The IM application refers to an application that instantly exchanges messages and performs social interaction based on the Internet. The IM application may include, but is not limited to, a social application that includes a communication function, a map application that includes a social interaction function, a game application, and the like. The content interaction application is an application that can implement content interaction. For example, the content interaction application may be an application such as online banking, a sharing platform, personal space, or news.

In some embodiments, the computer device may be a physical device having a video coding/decoding capability. Therefore, when the computer device is deployed with the partial detail enhancement solution for frame pictures provided in the embodiments of this application, a partial detail enhancement effect may be implemented by using all video frames coded and decoded by the computer device. The type of the computer device may include a terminal or a server. The terminal may include, but is not limited to, a terminal device such as a smartphone (e.g., a smartphone on which an Android system is deployed, or a smartphone on which an Internetworking operating system (IOS) is deployed), a tablet computer, a portable personal computer, a mobile Internet device (MID), an in-vehicle device, or a head-mounted device. Types of the terminal device are not limited in the embodiments of this application, which is hereby specified. The server may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform.

The foregoing only briefly describes a product form to which the partial detail enhancement solution for frame pictures provided in the embodiments of this application may be applied. During actual application, the embodiments of this application do not limit a product to which the partial detail enhancement solution for frame pictures may be applied. For example, the partial detail enhancement solution for frame pictures provided in the embodiments of this application may further be deployed in an application or a computer device in a form of a plug-in. For ease of description, a partial detail enhancement solution for frame pictures is described below by using an example in which the partial detail enhancement solution for frame pictures is deployed in an application and the application runs in a computer device. Details are described herein.

For a schematic architecture diagram of a video coding/decoding system based on a partial detail enhancement solution for frame pictures, refer to FIG. 5. As shown in FIG. 5, it is assumed that the partial detail enhancement solution for frame pictures is deployed in a social application, and the social application runs in a computer device, namely a terminal. The terminal in the video coding/decoding system may include a terminal 501 and a terminal 502, and the video coding/decoding system further includes a server 503. The embodiments of this application do not limit quantities and types of terminals and servers in the video coding/decoding system. The terminal 501 is a terminal device held by user 1, the terminal 502 is a terminal device held by user 2, and user 1 and user 2 are two users that have established a communication session in a social application. The server 503 is a background device corresponding to the terminal 501 and the terminal 502, and mainly provides background technologies and services to social applications in the terminal 501 and the terminal 502. The terminal (the terminal 501 or the terminal 502) and the server may be directly or indirectly connected to each other in a wired or wireless communication manner. This is not limited in this application herein.

In a specific implementation, in the video coding/decoding system shown in FIG. 2, if user 1 wants to share a video with user 2, user 1 may transmit a video on a social session page displayed on a display screen of the terminal 501. After receiving the video, the terminal 501 codes the video by using the partial detail enhancement solution for frame pictures provided in the embodiments of this application, to obtain a compressed bitstream. The compressed bitstream includes bitstream data of each video frame in the video. The terminal 501 transmits the compressed bitstream to the server 503, and the server 503 forwards the compressed bitstream to the terminal 502. After receiving the compressed bitstream, the terminal 502 decodes bitstream data of each video frame in the compressed bitstream, specifically, decodes the bitstream data by using the partial detail enhancement solution for frame pictures provided in the embodiments of this application, to obtain a reconstructed frame picture of the video frame. In view of this, in a video coding/decoding process, a dual-bitstream manner provided in the embodiments of this application is used, so that additional coding can be performed on to-be-enhanced details in a video frame, to improve an effect that an original picture of the video frame is restored to a greater extent when partial details in the video frame are decoded, thereby ensuring video coding quality and efficiency.

Based on the foregoing related content about the partial detail enhancement solution for frame pictures provided in the embodiments of this application, the following further needs to be described:

(1) Block partition information determined by a coder side, and mode information or parameter information (e.g., a model parameter of a cross-component prediction model or information such as a template selection manner) such as prediction, transform, quantization, entropy coding, and loop filtering are carried in a coding bitstream when necessary. In this way, the decoder side performs parsing based on the coding bitstream and performs analysis according to existing information, to determine mode information or parameter information, such as prediction, transform, quantization, entropy coding, and loop filtering, which is the same as that of the coder side, thereby ensuring that the decoded picture obtained by the coder side is the same as that of the decoded picture obtained by the decoder side. According to different processes of compressing the mode information or the parameter information by the coder side during coding, the parsing, by the decoder side, the mode information or the parameter information based on the coding bitstream may include, but is not limited to, two parsing manners. In some embodiments, the mode information or the parameter information may be directly parsed by parsing bits in the coding bitstream. For example, when a value of a parameter defined in the coding bitstream is 1, template region 1 is selected, and when a value of a parameter is 0, template region 2 is selected. In some embodiments, the mode information or the parameter information is implicitly exported from the coding bitstream. The implicit export herein may be understood as a process in which some intermediate parameters are parsed from the coding bitstream, these intermediate parameters are operated, and the mode information or the parameter information is exported based on an operation result. The decoder side may use either of the foregoing two manners to parse any mode information or parameter information based on the coding bitstream transmitted by the coder side. This is not limited.

(2) FIG. 5 is a schematic architecture diagram of an exemplary video coding/decoding system according to an embodiment of this application. During actual application, the architecture may be adaptively changed. For example, the server in the video coding/decoding system is a distributed server. To be specific, the server 503 is not a single device, but is a plurality of servers deployed at different positions in a distributed manner. For another example, the server 503 may not exist in the video coding/decoding system, and the terminal 501 and the terminal 502 directly communicate with each other.

(3) In the embodiments of this application, the collection and processing of relevant data are required to be strictly conducted in accordance with the requirements of relevant laws and regulations. The acquisition of personal information is required to obtain the knowledge or consent of the individual subject (or have a legitimate basis for information acquisition), and subsequent data usage and processing activities are carried out within the scope authorized by laws and regulations as well as the personal information subject. For example, when the embodiments of this application are applied to specific products or technologies, such as video transmission by a terminal, permission or consent is required to be obtained from an uploader or creator of the video, and the collection, use, and processing of relevant data are required to comply with the relevant laws, regulations and standards of the corresponding regions.

Based on the foregoing related descriptions of the partial detail enhancement solution for frame pictures and an applied product or scene architecture, the following describes a more detailed partial detail enhancement method for frame pictures provided in the embodiments of this application with reference to the accompanying drawings. The partial detail enhancement method for frame pictures specifically includes a coding method and a decoding method. The coding method describes a specific implementation process in which a coder codes a video frame, to obtain an original bitstream and a detail bitstream of the video frame. The decoding method describes a specific implementation process in which after receiving the original bitstream and the detail bitstream of the video frame, a decoder implements joint picture decoding with reference to the original bitstream and the detail bitstream, to obtain a reconstructed frame picture of the video frame. For ease of description, a coding method and a decoding method are respectively described in detail below by using different embodiments. Details are described herein.

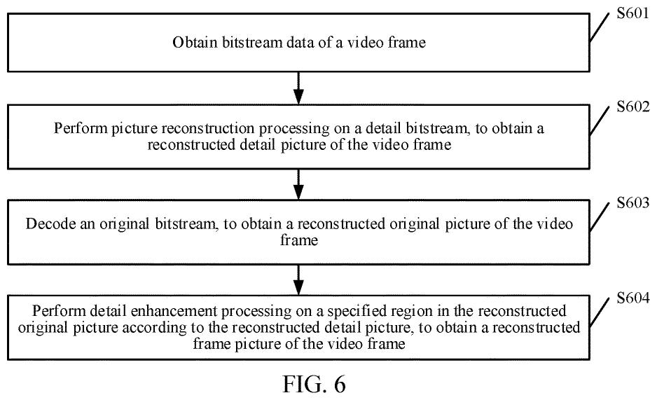

Referring to FIG. 6, FIG. 6 is a schematic flowchart of a decoding method according to an exemplary embodiment of this application. The schematic flowchart shown in FIG. 6 is a schematic flowchart of a decoder side, and may be specifically performed by a computer device held by the decoder side. The method may include, but is not limited to, operations S601 to S604:

S601: Obtain bitstream data of a video frame.

The video frame is a current to-be-decoded video frame among a plurality of video frames included in a video. After receiving a compressed bitstream of the video transmitted by a coder, a decoder sequentially decodes the video frames according to an arrangement order (or a play order) of the video frames in the video. When the decoder needs to decode any video frame, bitstream data of the video frame is obtained from the compressed bitstream of the video.

The bitstream data of the video frame includes an original bitstream and a detail bitstream of the video frame. The original bitstream of the video frame may be understood as a bitstream obtained by the coder by coding the entire video frame. The detail bitstream of the video frame may be understood as a bitstream obtained by the coder by coding a specified region in the video frame. The specified region refers to a to-be-detail-enhanced region in the video frame, namely a picture region having a large information/precision loss during coding of the video frame.

S602: Perform picture reconstruction processing on a detail bitstream, to obtain a reconstructed detail picture of the video frame.

After obtaining the detail bitstream of the video frame, the decoder first decodes the detail bitstream, to obtain residual information of a pixel within the specified region in a reconstructed detail picture to be reconstructed. The residual information is obtained by the coder by performing a subtraction operation on original pixel information and prediction information of a pixel, and codes the residual information into the detail bitstream. The decoding, by the decoder, a detail bitstream of the video frame specifically includes: performing entropy decoding on the detail bitstream, to obtain coding mode information and a quantized quantization coefficient that are used when the coder codes the pixel within the specified region in the video frame. Entropy decoding is a reverse process of entropy coding in the foregoing coding process, and is intended to restore a binary detail bitstream to the quantized quantization coefficient. The decoder then performs inverse quantization on the quantization coefficient, to obtain a transform coefficient. The inverse quantization is a reverse process of the foregoing quantization in the coding process, and is intended to convert the quantization coefficient into a transform coefficient in a transform domain. The decoder then performs inverse transform on the transform coefficient, to obtain residual information of each pixel within the specified region in the video frame. The inverse transform is a reverse process of transform in the foregoing coding process, and is intended to convert the transform coefficient into a residual signal (i.e., residual information).

As described above, the specified region refers to the to-be-detail-enhanced region in the video frame rather than all regions in the video frame. Therefore, to facilitate the decoder side to know the position of the specified region in the video frame, in the embodiments of this application, the coder side is supported to code the position of the specified region in the video frame into the detail bitstream in a form of an identifier. In this way, the decoder side may further obtain an identifier by decoding the detail bitstream of the video frame. The identifier is configured for indicating a position of the specified region in the video frame. For example, the identifier indicates the position of the specified region in the video frame in a coordinate manner. For example, the identifier indicates coordinates of two vertexes of a diagonal of the specified region in the video frame. The decoder side may determine a position of the specified region in the video frame according to the position indicated by the identifier, and decode pixels within the specified region, to obtain residual information of pixels within a specified region in a reconstructed detail picture to be reconstructed. In view of this, by adding the identifier to the detail bitstream, the decoder side quickly knows the position of the specified region in the video frame by using the identifier, thereby implementing secure and fast transmission of the position of the specified region between the coder and decoder sides. The position of the specified region in the video frame is implemented by adding the identifier to the detail bitstream, and position information of the specified region (i.e., the position of the specified region in the video frame) and the like may be transmitted by offline communication between the decoder side and the coder side. A manner of transferring the position information of the specified region between the coder and decoder sides is not limited in the embodiments of this application.

Then, the decoder obtains coding mode information obtained by decoding the detail bitstream. The coding mode information includes a prediction mode (such as an intra prediction mode or an inter prediction mode) used when the coder performs predictive coding on pixels within the specified region in the video frame. In this way, the decoder may perform prediction processing on the pixels within the specified region according to the coding mode information by using the same predictive coding manner as the coder, to obtain prediction information of the pixels within the specified region in the reconstructed detail picture to be reconstructed.

Finally, after the residual information and the prediction information of the pixels within the specified region in the reconstructed detail picture are obtained based on the foregoing operations, the decoder may obtain the reconstructed detail picture of the video frame based on the residual information of the pixels within the specified region and the prediction information of the pixels within the specified region. Specifically, the residual information of the pixels within the specified region and the prediction information of the corresponding pixels are added, to obtain reconstructed pixel information of the corresponding pixels, thereby obtaining a reconstructed detail picture of the video frame.

In view of this, in the embodiments of this application, a specified region in which a pixel having a large information loss in a coding process is located is identified from the video frame to obtain a detail picture, and the detail picture is additionally coded to obtain a detail bitstream. In this way, the decoder side may reconstruct the detail bitstream, so as to restore a reconstructed detail picture of the specified region in the video frame, and may supplement pixels of the specified region of the video frame that has information loss caused by coding, thereby improving video coding/decoding quality and efficiency.

S603: Decode an original bitstream, to obtain a reconstructed original picture of the video frame.

Specifically, the decoding, by the decoder, an original bitstream of the video frame specifically includes: performing entropy decoding on the original bitstream, to obtain coding mode information and a quantized quantization coefficient that are used when the coder codes each pixel in the video frame; performing inverse quantization on the quantization coefficient, to obtain a transform coefficient; and then performing inverse transform on the transform coefficient, to obtain residual information of each pixel in the video frame. In addition, the decoder obtains coding mode information obtained by decoding the original bitstream. The coding mode information includes a prediction mode used when the coder performs predictive coding on each pixel in the video frame. The decoder performs prediction processing on each pixel in the video frame according to the coding mode information by using the same predictive coding manner as that of the coder, to obtain prediction information of each pixel in a reconstructed original picture to be reconstructed. Finally, the decoder obtains the reconstructed original picture of the video frame based on the residual information of each pixel and the prediction information of the corresponding pixel in the video frame. Specifically, the residual information of each pixel in the video frame and the prediction information of the corresponding pixel are added, to obtain reconstructed pixel information of the corresponding pixels, thereby obtaining a reconstructed original picture of the video frame.

A specific implementation process in which the decoder performs decoding processing on the original bitstream of the video frame is similar to a specific implementation process in which the decoder performs picture reconstruction processing on the detail bitstream of the video frame. The foregoing only briefly describes the decoding process of the original bitstream. For detailed content, refer to related descriptions of the foregoing decoding process of the detail bitstream. Details are not described herein again. In addition, the decoder may first perform decoding processing on the original bitstream, or first perform picture reconstruction processing on the detail bitstream. To be specific, an order in which the decoder performs operation S602 and operation S603 is not limited in the embodiments of this application.

S604: Perform detail enhancement processing on a specified region in the reconstructed original picture according to the reconstructed detail picture, to obtain a reconstructed frame picture of the video frame.

After the reconstructed detail picture and the reconstructed original picture of the video frame are obtained based on the foregoing operations, it is considered that the reconstructed detail picture includes reconstructed pixel information of pixels within a to-be-detail-enhanced region (i.e., a specified region) in the reconstructed original picture. Therefore, the decoder side may optimize, by using the reconstructed pixel information of the pixels within the specified region in the reconstructed detail picture, the reconstructed pixel information of the corresponding pixels within the specified region in the reconstructed original picture. The optimization refers to: adjusting, according to the reconstructed pixel information of the pixels within the specified region in the reconstructed detail picture, the reconstructed pixel information of the corresponding pixels within the specified region in the reconstructed original picture in a direction from which the reconstructed pixel information of the corresponding pixels within the specified region in the reconstructed original picture approaches original pixel information of the corresponding pixels within the specified region in the original video frame. In view of this, even if the coder loses some information due to a quantization operation in the process of coding the video frame, in the embodiments of this application, by additionally coding the specified region that has a relatively large amount of information lost in the video frame, it may be ensured that the decoder can still obtain most information that may be lost in the specified region in the coding process, thereby further improving prediction accuracy of reconstructed pixel information of pixels within the specified region in the video frame when it is ensured that reconstructed pixel information of pixels within a non-specified region in the video frame is relatively accurate, thereby improving reconstruction quality of the entire reconstructed frame picture.

A picture size of the reconstructed detail picture is the same as a picture size of the reconstructed original picture, and the position of the specified region in the reconstructed detail picture is the same as the position of the specified region in the reconstructed original picture, pixels in the reconstructed detail picture and pixels in the reconstructed original picture are in a one-to-one correspondence. The one-to-one correspondence means that a pixel within the specified region in the reconstructed detail picture and a pixel within the specified region in the reconstructed original picture both correspond to corresponding pixels (i.e. at the same position) within the specified region in the video frame. Based on this, the decoder side performs detail enhancement processing/optimization on the specified region in the reconstructed original picture according to the reconstructed detail picture. Specifically, reconstructed pixel information of the pixels within the specified region in the reconstructed detail picture is superimposed onto reconstructed pixel information of the corresponding pixels within the specified region in the reconstructed original picture. In addition, reconstructed pixel information of non-superimposed pixels in the reconstructed original picture is reserved, to obtain a reconstructed frame picture corresponding to the video frame.

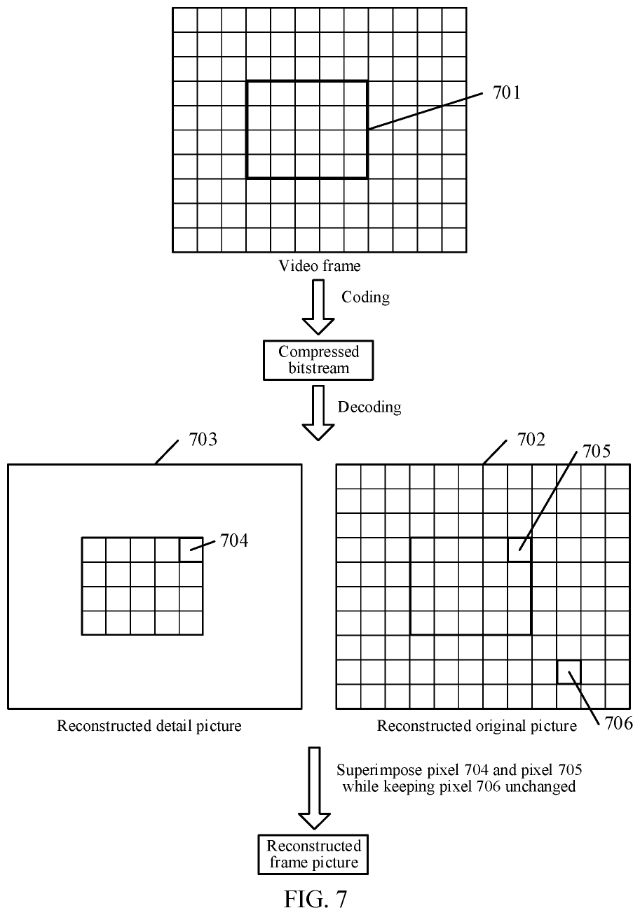

As shown in FIG. 7, positions of a specified region 701 in a video frame in a reconstructed original picture 702 and a reconstructed detail picture 703 are the same. When performing detail enhancement processing on the specified region in the reconstructed original picture 702 according to the reconstructed detail picture 703, the decoder side specifically superimposes reconstructed pixel information of a pixel (e.g., a pixel 704) within the specified region in the reconstructed detail picture 703 and reconstructed pixel information of a corresponding pixel (e.g., a pixel 705) within the specified region in the reconstructed original picture 702, to obtain new reconstructed pixel information of the pixel 705. Meanwhile, the reconstructed original picture 702 further includes a pixel (e.g., a pixel 706) outside the specified region, and reconstructed pixel information of the pixel 706 is reserved, to obtain a reconstructed frame picture corresponding to the video frame. Assuming that reconstructed pixel information of the pixel 704 is first reconstructed pixel information, and reconstructed pixel information of the pixel 705 is second reconstructed pixel information, reconstructed pixel information of the pixel 705 in a specified region in the reconstructed frame picture=first reconstructed pixel information +second reconstructed pixel information. Reconstructed pixel information of the pixel 706 in a non-specified region in the reconstructed frame picture is reconstructed pixel information of the pixel 706 in the reconstructed original picture.

The decoder side performs detail enhancement processing on the specified region in the reconstructed original picture according to the reconstructed detail picture. In addition to the direct superimposition manner mentioned above, another manner may be used. For example, the reconstructed pixel information of the pixels within the specified region in the reconstructed original picture is optimized in a weight superimposition manner. To be specific, the reconstructed pixel information of the pixels within the specified region in the reconstructed detail picture is superimposed onto the reconstructed pixel information of the corresponding pixels within the specified region in the reconstructed original picture in a particular proportion. The proportion may be compressed into the detail bitstream at the coder side. In this way, the decoder side may directly obtain the proportion by decoding the detail bitstream. When the reconstructed pixel information of the pixels within the specified region in the reconstructed original picture is optimized by means of the weight superimposition, when a difference between the reconstructed pixel information of the pixels within the specified region in the reconstructed original picture and original pixel information of the pixels in the video frame is relatively small, an error caused by excessive superimposition of the reconstructed pixel information can be avoided, and quality of the reconstructed pixel information of the pixels can be improved.

In the embodiments of this application, the decoder side may perform picture reconstruction processing by using the detail bitstream of the video frame, to obtain a reconstructed detail picture of the video frame. The reconstructed detail picture includes reconstructed pixel information of pixels in the to-be-detail-enhanced specified region. To be specific, by reconstructing a detail picture in the coding process, detail content of a partial region (i.e., the specified region) of the video frame lost in the coding process can be restored by using the reconstructed detail picture. Meanwhile, the decoder side also reconstructs a reconstructed original picture of the video frame through the original bitstream of the video frame. In this way, the decoder side may perform detail enhancement processing on the specified region in the reconstructed original picture according to the reconstructed detail picture, to obtain a reconstructed frame picture of the video frame. Since the reconstructed frame picture is obtained by optimizing pixels within the specified region in the reconstructed original picture by using the reconstructed detail picture, the reconstructed pixel information of the pixels included in the reconstructed frame picture has a high degree of restoration relative to the pixel information of the corresponding pixels in the original video frame. To be specific, the reconstructed pixel information of the pixels in the reconstructed frame picture is identical or similar to the pixel information of the corresponding pixels in the original video frame. In view of this, in the embodiments of this application, in a dual-bitstream coding/decoding manner, in a process where the decoder side restores the entire video frame by using the original bitstream, detail enhancement is performed on the to-be-detail-enhanced specified region in the restored video frame by using the detail bitstream, thereby effectively improving the reconstruction quality of the pixels within the specified region lost in the coding process of the video frame, reducing precision losses caused by a prediction residual and quantization in a video coding process, and improving coding/decoding efficiency.

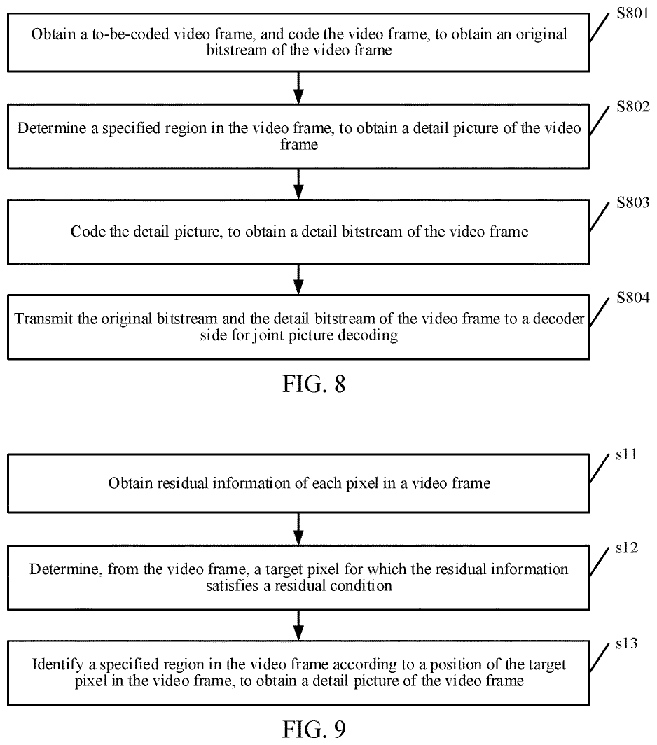

The foregoing embodiment in FIG. 6 describes, from the decoder side, a specific implementation process of the decoding method provided in the embodiments of this application. A specific implementation process of the coding method performed by the coder side is described below by using FIG. 8. Referring to FIG. 8, FIG. 8 is a schematic flowchart of a coding method according to an exemplary embodiment of this application. The schematic flowchart shown in FIG. 8 may be performed by a computer device held by a coder side. The method may include, but is not limited to, operations S801 to S804:

S801: Obtain a to-be-coded video frame, and code the video frame, to obtain an original bitstream of the video frame.

The to-be-coded video frame is any video frame in a to-be-coded video, and a coder performs the same coding on each video frame in the to-be-coded video, to obtain a compressed bitstream. In the embodiments of this application, a partial detail enhancement method for frame pictures is described by using an example in which a video frame is coded. Details are described herein.

After obtaining the to-be-coded video frame, a decoder side codes the video frame, and codes the video frame into an original bitstream. The video frame coding is coding the entire video frame. For a specific implementation process of coding processing, refer to the foregoing related introduction to the video coding/decoding technology. The coding processing includes, but is not limited to: first partitioning a video frame, to obtain a plurality of blocks; performing predictive coding (e.g., prediction using an intra prediction mode) on a current block (i.e., a block that currently needs to be coded), to obtain prediction information of pixels in the current block; subtracting the prediction information from original pixel information of the pixels in the current block, to obtain residual information of the pixels in the current block; sequentially performing transform and quantization on the residual information of the pixels in the current block, to obtain a quantization coefficient; and processing each pixel in the video frame, to obtain a quantization coefficient of each pixel, and then performing entropy coding on the quantization coefficients, to obtain a binary original bitstream.

S802: Determine a specified region in the video frame, to obtain a detail picture of the video frame.

As described above, considering that information loss caused by predictive coding and quantization exists in the process of coding the video frame shown in operation S801, pixels within a specified region having a large information loss in the video frame can be additionally coded, so that information lost at the coder side can still be obtained at the decoder side, thereby ensuring video frame reconstruction quality at the decoder side.

During actual application, when the coder side performs a quantization operation on the residual information, larger residual information indicates a larger quantization loss. Therefore, the embodiments of this application support screening, from the video frame according to the residual information of the pixels, a region of a pixel having large residual information as a to-be-detail-enhanced specified region for additional coding. By way of example, for a specific implementation process of determining the specified region from the video frame according to the residual information of the pixels, refer to FIG. 9. The process includes, but is not limited to, operations s11 to s13:

s11: Obtain residual information of each pixel in a video frame.

In a process in which the coder codes the video frame shown in operation S801, the coder predicts prediction information of each pixel in the video frame through predictive coding, and then subtracts corresponding prediction information from original pixel information of each pixel, to obtain residual information of each pixel. In this way, when the specified region is determined from the video frame, only the residual information of each pixel generated during coding of the video frame needs to be directly obtained.

s12: Determine, from the video frame, a target pixel for which the residual information satisfies a residual condition.

The residual condition is a condition for determining whether the residual information needs to be additionally coded, where the residual information is a difference between original pixel information and prediction information of a pixel. In the embodiments of this application, considering that larger residual information loses more information when being quantized, the residual condition is intended to screen the larger residual information from the video frame, so as to additionally code the larger residual information into the detail bitstream. In the embodiments of this application, a plurality of screening policies are provided to determine whether a pixel is a target pixel for which residual information satisfies a residual condition. The following describes the plurality of policies in detail.

(1) An entire video frame corresponds to one residual threshold T, where T is a natural number greater than or equal to zero. In this case, the screening policy is: screening a pixel for which residual information is greater than the residual threshold T in the video frame as a target pixel for which residual information satisfies the residual condition. In this case, the residual condition is that the residual information is greater than the residual threshold T. By directly comparing the residual information with the residual threshold T to screen the target pixel, large residual information may be directly screened from the video frame, which has advantages of simplicity and convenience.

In a specific implementation, the coder compares the residual information of each pixel in the video frame with the residual threshold T, to obtain a residual comparison result of each pixel. The residual comparison result of any pixel is configured for indicating a magnitude relationship between the residual information of the pixel and the residual threshold T. For example, the residual information of any pixel is greater than the residual threshold T, the residual information of any pixel is equal to the residual threshold T, or the residual information of any pixel is greater than the residual threshold T. Then, a pixel for which the residual information is greater than the residual threshold is determined as the target pixel from the video frame based on the residual comparison result of each pixel.

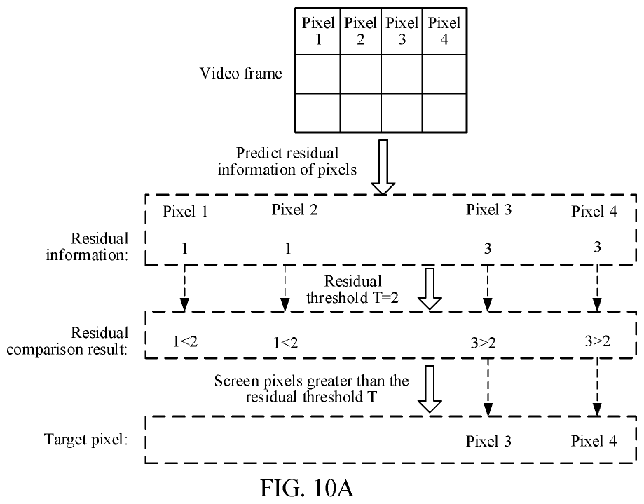

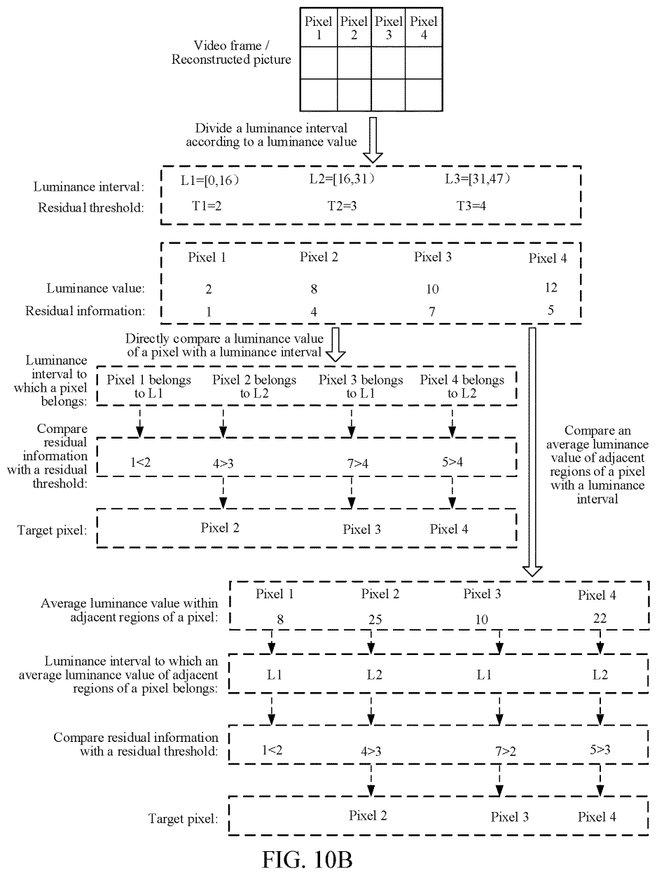

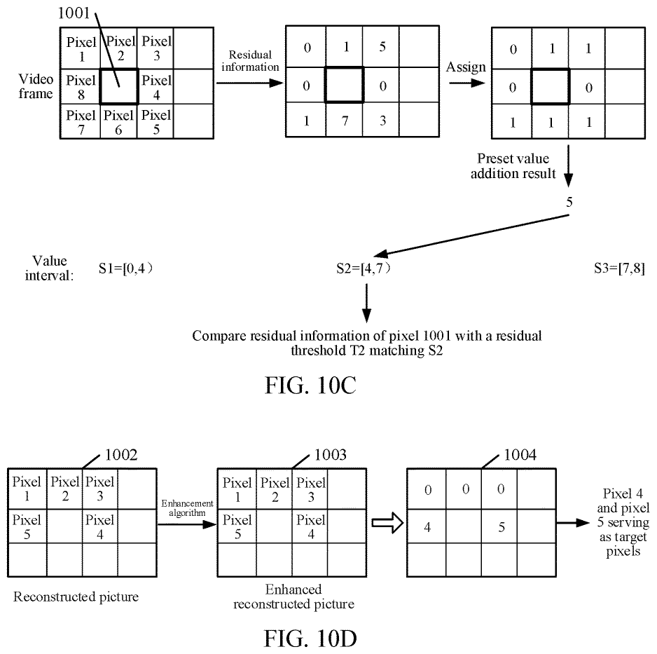

For a schematic flowchart of screening a target pixel from a video frame according to a residual comparison result, refer to FIG. 10A. As shown in FIG. 10A, it is assumed that a residual threshold T corresponding to a video frame is 2, residual information of pixel 1 in the video frame is 1, residual information of pixel 2 is 1, residual information of pixel 3 is 3, residual information of pixel 4 is 3, and so on. Then, the residual information of pixel 1, pixel 2, pixel 3, and pixel 4 is compared with the residual threshold T, to obtain a residual comparison result of pixel 1, indicating that the residual information of pixel 1 is less than the residual threshold T, the residual information of pixel 2 is less than the residual threshold T, the residual information of pixel 3 is greater than the residual threshold T, and the residual information of pixel 4 is greater than the residual threshold T. In this way, pixel 3 and pixel 4 for which the residual comparison result indicates that the residual information is greater than the residual threshold T are used as target pixels, and pixel 1 and pixel 2 for which the residual comparison result indicates that the residual information is less than or equal to the residual threshold T are zero residuals by default.

(2) Partition N luminance intervals according to luminance values of pixels in the video frame, and set a matching residual threshold for each luminance interval, where N is a positive integer. In this case, the screening policy is: determining a target luminance interval to which a luminance value of a pixel or an average luminance value of a region adjacent to the pixel belongs; and using a pixel for which the luminance value of the pixel or the average luminance value of the region adjacent to the pixel is less than a residual threshold matching the target luminance interval as a target pixel for which residual information satisfies a residual condition. In this case, the residual condition is: the luminance value of the pixel or the average luminance value of the region adjacent to the pixel belongs to the target luminance interval, and the luminance value of the pixel or the average luminance value of the region adjacent to the pixel is less than the residual threshold matching the target luminance interval.

In a specific implementation, for a detailed procedure of screening a target pixel based on both a luminance value and residual information, refer to a schematic flowchart shown in FIG. 10B. As shown in FIG. 10B:

1) Obtain N luminance intervals arranged in an ascending order of luminance values, and a residual threshold matching each luminance interval. The source of the obtained luminance value herein may include: an original luminance value of each pixel in the video frame, or a luminance value of a reconstructed pixel of each pixel obtained by reconstructing an original bitstream of the video frame. As shown in FIG. 10B, it is assumed that a minimum luminance value of a pixel in a video frame is 0 and a maximum luminance value is 255. Then, N luminance intervals are partitioned in an ascending order of luminance, namely luminance values from 0 to 255. The N luminance intervals are respectively L1→L2→L3→ . . . →LN in order. For example, a luminance interval L1=[0, 16), a luminance interval L2=16, 31), and a luminance interval L3=[31, 47). For each luminance interval Li (i=1, 2, 3, . . . , and N), a residual threshold Ti is set (e.g., T1=2, T2=3, T3=4, and T4=2). Considering that a smaller maximum luminance value within the luminance interval indicates darker luminance of a pixel falling into the luminance interval, more information is more likely to be lost when the pixel is predictively coded and quantized. Then, a smaller residual threshold may be set for the luminance interval, to ensure that more pixels for which luminance values fall into the luminance interval can be additionally coded as target pixels. In view of this, this manner of partitioning a luminance value into luminance intervals, and setting matching residual thresholds for different luminance intervals may better adapt to a case that pixel prediction residual information of different luminance values differs in a video frame coding/decoding process.

2) Obtain a luminance value of each pixel in the video frame, and determine a target luminance interval to which the luminance value of each pixel belongs.

In some embodiments, it is supported to directly compare the luminance value of each pixel with the N luminance intervals, to determine a target luminance interval to which the luminance value of each pixel belongs. In short, the luminance value of each pixel in the video frame is compared with luminance values included in the N luminance intervals, and the target luminance interval to which the luminance value of each pixel belongs is determined. As shown in FIG. 10B, it is assumed that a luminance value of pixel 1 is 8, a luminance value of pixel 2 is 19, a luminance value of pixel 3 is 42, and a luminance value of pixel 4 is 43. Then, it is determined that a target luminance interval to which the luminance value of pixel 1 belongs is luminance interval L1, a target luminance interval to which the luminance value of pixel 2 belongs is luminance interval L2, and a target luminance interval to which the luminance values of pixel 3 and pixel 4 belong is luminance interval L3.

In some embodiments considering that a difference between a luminance value of a pixel in the video frame and luminance values of surrounding pixels is small, comparison between an average luminance value of all pixels within a region adjacent to the pixel and the N luminance intervals is further supported, to determine a target luminance interval to which the luminance value of each pixel belongs. Specifically, an average luminance value of a region adjacent to each pixel in the video frame is obtained. The region adjacent to the pixel herein may be a region in which the pixel is located in the video frame, and this region includes the pixel. For example, a size of this region is 8×8. The average luminance value of the region adjacent to the pixel is obtained by performing an average operation on luminance values of all pixels within the region adjacent to the pixel. As shown in FIG. 10B, assuming that a size of a region adjacent to pixel 1 is 2×2, and 4 luminance values within the region adjacent to pixel 1 are respectively a luminance value 2 of pixel 1, a luminance value 8 of pixel 2, a luminance value 10 of pixel 5, and a luminance value 12 of pixel 6, an average luminance value of the region adjacent to pixel 1 is calculated as 2+8+10+12/4=8. If the average luminance value 8 falls within a luminance interval L1, the luminance interval L1 is used as a target luminance interval to which the luminance value of pixel 1 belongs.

3) Compare residual information of each pixel in the video frame with a residual threshold matching the target luminance interval, determine a pixel for which the residual information is greater than the corresponding residual threshold as the target pixel, and determine a pixel for which the residual information is less than or equal to the corresponding residual threshold as a zero residual.

As shown in FIG. 10B, when a luminance value of a pixel is directly compared with N luminance intervals, residual information of pixel 1 is compared with a residual threshold T1 matching a luminance interval L1, residual information of pixel 2 is compared with a residual threshold T2 matching a luminance interval L2, a residual threshold of pixel 3 is compared with a residual threshold T3 matching a luminance interval L3, and a residual threshold of pixel 4 is compared with a residual threshold T3 matching a luminance interval L3. If residual information of pixel 1 is 1, residual information of pixel 2 is 4, residual information of pixel 3 is 7, residual information of pixel 4 is 5, and T1=2, T2=3, and T3=4, it is determined that pixel 2, pixel 3, and pixel 5 are target pixels for which the residual information is greater than corresponding residual thresholds.

As shown in FIG. 10B, when the target pixel is determined based on both the luminance value and the residual information, it is calculated that an average luminance value 8 of the region adjacent to pixel 1 falls within the luminance interval L1, and the residual information of pixel 1 is compared with the residual threshold T1 matching the luminance interval L1. Assuming that T1=2 and the residual information of pixel 1 is 1, it is determined that pixel 1 is not a target pixel for which the residual information is greater than the residual threshold. Similarly, pixel 2, pixel 3, and pixel 4 are determined in the same manner as pixel 1, and a result about whether pixel 2, pixel 3, and pixel 4 are target pixels may be obtained.

In conclusion, in the embodiments of this application, a target pixel needing to be additionally coded is screened by combining both a luminance value and residual information, thereby effectively improving screening accuracy of the target pixel.

(3) Dynamically set a residual threshold when non-zero residual information exists around a current pixel. The screening policy is: setting M value intervals according to residual information of a plurality of pixels adjacent to a pixel in a video frame, M being a positive integer; setting a matching residual threshold for each value interval, N being a positive integer; assigning values to the residual information of the plurality of pixels adjacent to any pixel, and performing an addition operation on the values assigned to the plurality of assigned pixels; determining, according to an addition result, a target value interval to which any pixel belongs; and taking any pixel as a target pixel for which the residual information satisfies a residual condition when the residual information of any pixel is greater than a residual threshold matching a target value interval.

In a specific implementation, for a detailed procedure of screening a target pixel when non-zero residual information exists around a current pixel, refer to a schematic flowchart shown in FIG. 10C. As shown in FIG. 10C:

Preset operation: It is assumed that a value of residual information of a pixel for which residual information is non-zero in a video frame is assigned to a first preset value (e.g., the first preset value is 1), and a value of residual information of a pixel for which residual information is zero in the video frame is assigned to a second preset value (e.g., the second preset value is 0). Therefore, for Q pixels (Q is a positive integer, e.g., Q=8) adjacent to a pixel, if a range of a sum of residual information after values are assigned to 8 pixels (e.g., 8 pixels located at the top, bottom, left, right, top-left, bottom-left, top-right, and bottom-right positions of the pixel) around the pixel is [0, 8], a maximum value in the range is a sum of Q first preset values (i.e., 8), and a minimum value in the range is a sum of Q second preset values (i.e., 0). Then, M value intervals are set according to the range [0, 8]. If M=3, a value interval S1=[0, 4), a value interval S2=[4, 7), and a value interval S3=[7, 8] may be set. A maximum value in the M=3 value ranges is a sum of Q first preset values, and a minimum value is a sum of Q second preset values. Further, a matching residual threshold is set for each set value interval. Considering that if a large quantity of residual information of pixels around a current pixel is assigned with the second preset value, to be specific, a smaller sum of the plurality of pixels around the current pixel is assigned, it can be represented to some extent that accuracy of the pixel is high during predictive coding. To be specific, there is a large probability that the pixel is a pixel that does not need to be additionally coded, a higher residual threshold may be set for a value interval having a small value, and a lower residual threshold may be set for a value interval having a relatively large value, to additionally code residual information of a pixel within a region with poor accuracy during predictive coding. For example, a residual threshold T1=7 is set for the value interval S1, a residual threshold T2=4 is set for the value interval S2, and a residual threshold T3=2 is set for the value interval S3.

Real-time screening operation: When it is necessary to determine whether a pixel in a video frame is a target pixel, M value intervals arranged in descending order of values and a residual threshold matching each value interval are obtained. The value herein is a sum of residual information after values are assigned to Q pixels around the pixel. Then, residual information of each pixel in Q pixels adjacent to any pixel needing to be determined in the video frame is obtained, and non-zero residual information among the residual information of the Q pixels is marked as a first preset value. In this way, an addition operation is performed on marked first predicted values in the Q pixels to obtain a preset value addition result, and a target value interval to which any pixel belongs is determined according to the preset value addition result. Finally, the residual information of any pixel is compared with a residual threshold matching the target value interval. Any pixel is determined as the target pixel if the residual information of any pixel is greater than a residual threshold matching the target value interval. As shown in FIG. 10C, assuming that residual information of 8 pixels around pixel 1001 is: residual information of pixel 1 is 0, residual information of pixel 2 is 1, residual information of pixel 3 is 5, residual information of pixel 4 is 0, residual information of pixel 5 is 3, residual information of pixel 6 is 7, residual information of pixel 7 is 1, and residual information of pixel 8 is 0, the residual information of pixel 2, pixel 3, pixel 5, pixel 6, and pixel 7 is assigned with a first preset value 1, and a preset value addition result after assignment is calculated as 5. If it is detected that the preset value addition result of 5 falls within a value interval S2=[4, 7), the residual information of pixel 1001 is compared with a residual threshold T2 matching the value interval S2. If the preset value addition result of 5 is greater than the residual threshold T2, pixel 1001 is determined as a target pixel. The process of determining whether other pixels in the video frame except pixel 1001 are target pixels is the same as the process of determining whether pixel 1001 is a target pixel. Refer to the foregoing descriptions. Details are not described herein again.

1) FIG. 10C is described by using an example in which the first preset value is 1 and the second preset value is 0. In other implementations, the first preset value may be 0, and the second preset value may be 1. In this case, the principle to be followed when setting residual thresholds for the M value intervals is that a lower residual threshold is set for a smaller value interval, and a higher residual threshold is set for a larger value interval. Alternatively, in other implementations, the first preset value and the second preset value may be set to other values. The embodiments of this application do not limit the magnitudes of the first preset value and the second preset value, as long as the residual thresholds of the value intervals are set correspondingly. 2) FIG. 10C is described by using an example in which Q=8. In another implementation, Q may alternatively be another number, for example, Q=4, and only pixels located above, below, to the left of, and to the right of a current pixel are selected for determining. 3) For pixels located at an edge of the video frame, when a quantity P of surrounding pixels is less than Q (P is a positive integer), Q-P pixels may be selected from the vicinity of the adjacent pixels for determining. Alternatively, determining may be performed directly using the P pixels.

In conclusion, the embodiments of this application support assisting in determining an information loss degree during coding of a pixel according to the residual information of each pixel in a plurality of pixels adjacent to the pixel in the video frame. For example, a large number of pixels in the plurality of pixels adjacent to the pixel with large residual information indicates that the information loss degree during coding of the pixel may be high, thereby improving the screening accuracy of target pixels.

(4) Screen target pixels according to an enhancement algorithm. The screening policy is: reconstructing, at the coder side, the original bitstream of the video frame to obtain a reconstructed picture of the video frame; and applying an enhancement algorithm to the reconstructed picture to obtain an enhanced reconstructed picture. In this case, pixels in a difference picture between the enhanced reconstructed picture and a non-enhanced reconstructed picture are taken as target pixels for which residual information satisfies a residual condition.

To be specific, the embodiments of this application support performing picture reconstruction based on the original bitstream of the video frame coded locally at the coder side to obtain a reconstructed picture corresponding to the video frame, and then performing picture enhancement processing on the reconstructed picture to obtain an enhanced reconstructed picture. The picture enhancement processing herein is intended to enhance regions of poor quality (e.g., low luminance and blurriness) in the reconstructed picture by using an enhancement algorithm, so as to improve the picture quality of the enhanced reconstructed picture. The embodiments of this application impose no limitation on the type of the enhancement algorithm. For example, the enhancement algorithm may be an edge enhancement algorithm (for detail enhancement on edges of the reconstructed picture). In this way, a difference operation is performed between the enhanced reconstructed picture and the reconstructed picture to obtain a difference picture. The difference picture includes enhanced pixel information of pixels enhanced in the enhanced reconstructed picture relative to the reconstructed picture. Such enhanced pixel information may be regarded as information potentially lost during the coding process. In this case, target pixels for which residual information satisfies a residual condition are determined in the difference picture, where the target pixels are pixels with non-zero enhanced pixel information in the difference picture. In view of this, the embodiments of this application support directly performing picture enhancement processing on the reconstructed picture from the original bitstream at the decoder side, thereby analyzing an enhanced reconstructed picture of the video frame that can be detail-enhanced. In this way, target pixels with severe information loss during coding in the video frame may be deduced inversely, thereby improving the screening accuracy of target pixels.

As shown in FIG. 10D, the coder performs picture reconstruction on an original bitstream of a video frame to obtain a reconstructed picture 1002 of the video frame, and performs picture enhancement processing on the reconstructed picture 1002 to obtain an enhanced reconstructed picture 1003. Then, a difference picture 1004 between the enhanced reconstructed picture 1003 and the reconstructed picture 1002 is calculated. Pixels with non-zero enhanced pixel information in the difference picture 1004 are taken as target pixels. For example, if pixel information of pixel 1, pixel 2, and pixel 3 in the enhanced reconstructed picture 1003 is the same as pixel values in the reconstructed picture 1002, the enhanced pixel information of pixel 1, pixel 2, and pixel 3 in the difference picture is zero, and thus pixel 1, pixel 2, and pixel 3 are not target pixels. On the contrary, if pixel information of pixel 4 and pixel 5 in the enhanced reconstructed picture 1003 is different from pixel values in the reconstructed picture 1002, the enhanced pixel information of pixel 4 and pixel 5 in the difference picture is non-zero, and thus pixel 4 and pixel 5 are target pixels.

The foregoing four screening policies provided in the embodiments of this application are all examples, intended to screen pixels to be optimized or enhanced from the pixels of the video frame. During actual application, other screening policies may be adopted. The embodiments of this application are not limited thereto.

s13: Identify a specified region in the video frame according to a position of the target pixel in the video frame, to obtain a detail picture of the video frame.

After determining the target pixels to be additionally coded from the video frame based on the foregoing operations, it is necessary to identify a region where the target pixels are located in the video frame. The region where the target pixels are located serves as a to-be-detail-enhanced region in the video frame. The region may be referred to as a specified region in the video frame, thereby obtaining a detail picture of the video frame. The detail picture includes pixel information of pixels within the specified region in the video frame. By partitioning the video frame into regions and gradually narrowing the scope to determine the specified region, the accuracy of determining the specified region is effectively improved.

In a specific implementation, the video frame may be partitioned into at least two first regions corresponding to the video frame. For example, the video frame is partitioned according to a fixed region size (e.g., 8×8) to obtain at least two first regions, where a region size of each first region is smaller than a size of the video frame. It is determined whether a first region including target pixels for which residual information is greater than a residual threshold (pixels screened according to any screening policy provided in the foregoing operation s12) exists among the at least two first regions. If any first region among the at least two first regions includes target pixels, the first region is identified as a specified region in the video frame. The embodiments of this application do not limit the magnitude of the fixed region size.

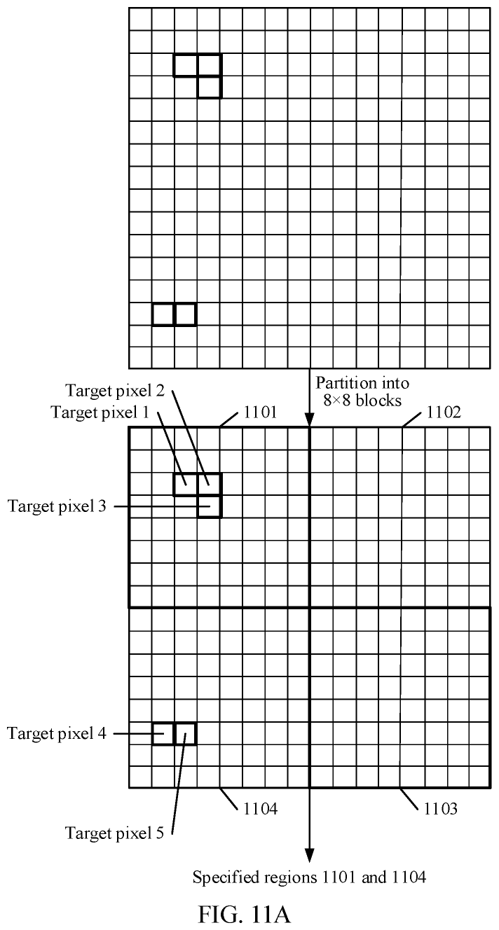

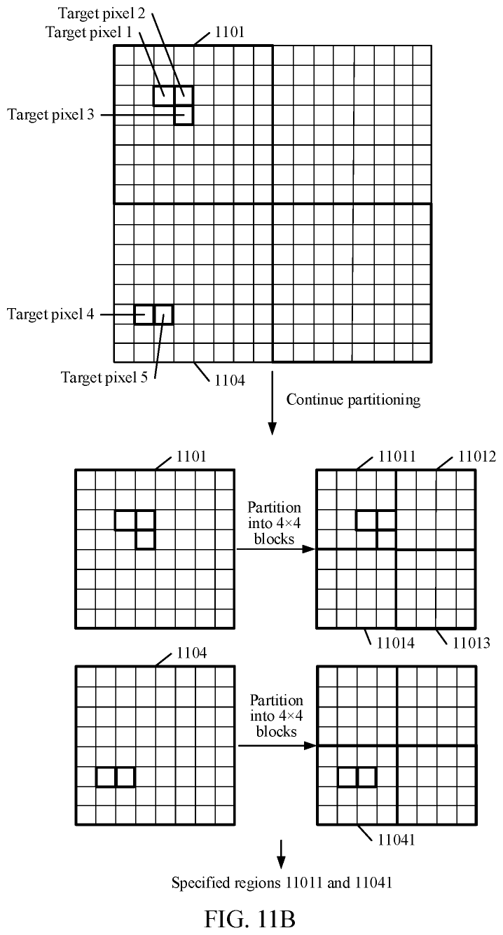

As shown in FIG. 11A, assuming that the video frame has a size of 16×16 and the fixed region size is 8×8, the video frame is partitioned according to the fixed region size to obtain 4 first regions: first region 1101, first region 1102, first region 1103, and first region 1104. It is determined whether each first region among the four first regions includes target pixels. For example, first region 1101 includes target pixel 1, target pixel 2, and target pixel 3, first region 1104 includes target pixel 4 and target pixel 5, and first region 1102 and first region 1103 include no target pixels. Then, first region 1101 and first region 1104 may be determined as specified regions in the video frame, thereby obtaining a detail picture of the video frame. The detail picture retains pixel information of pixels within first region 1101 and first region 1104 (including target pixels and non-target pixels for which residual information is less than or equal to a residual threshold).

Further, considering that a first region determined according to a fixed size region may include a large number of non-target pixels for which the residual information is less than or equal to the residual threshold, the embodiments of this application support further partitioning the first region into second regions of a smaller size, and coding only second regions that include target pixels, thereby greatly saving coding resources and improving coding efficiency. In a specific implementation, assuming that any first region includes target pixels, any first region including the target pixel is partitioned, to obtain at least two second regions corresponding to the first region, a region area size of the second region being less than a region area size of the first region. For example, an 8×8 first region is partitioned according to a 4×4 size to obtain four second regions. It is then determined whether any second region including target pixels for which residual information is greater than a residual threshold exists among the at least two second regions. If any second region among the at least two second regions includes target pixels, the second region is identified as a specified region in the video frame.

As shown in FIG. 11B, taking the partitioning of first region 1101 as an example, first region 1101 has a size of 8×8. First region 1101 is partitioned according to a 4×4 size to obtain second region 11011, second region 11012, second region 11013, and second region 11014. Target pixel 1, target pixel 2, and target pixel 3 are located in second region 11011, while second region 11012, second region 11013, and second region 11014 include no target pixels. Thus, second region 11011 and second region 11014 are taken as specified regions in the video frame. Similarly, first region 1104 is further partitioned, to obtain second region 11041 including target pixel 4 and target pixel 5. In conclusion, the specified regions in the video frame are determined as second region 11011 and second region 11041.

If the partitioned second regions (e.g., second region 11011 and second region 11041) include many non-target pixels for which residual information is less than or equal to the residual threshold, such second regions may be further partitioned to improve coding efficiency. The embodiments of this application do not limit the number of region partitions, which is hereby specified.

Based on the foregoing operations s11 to s13, at the coder side, the embodiments of this application support providing a plurality of policies to determine target pixels to be enhanced from the video frame. Compared with selecting target pixels from a single dimension, this improves the accuracy of selecting target pixels to be enhanced in the video frame, thereby effectively improving the quality of video coding and decoding.

S803: Code the detail picture, to obtain a detail bitstream of the video frame.

The detail picture is a picture having a picture size equal to that of the video frame, and the detail picture includes one or more to-be-detail-enhanced specified regions. After obtaining the detail picture corresponding to the video frame based on the foregoing operations, the coder codes pixels within the specified region in the detail picture, to obtain a detail bitstream of the video frame. The coding processing herein specifically includes operations such as transform→quantization→entropy coding. For specific implementations of operations such as transform, quantization, and entropy coding, refer to the foregoing related descriptions. Details are not described herein again.

S804: Transmit the original bitstream and the detail bitstream of the video frame to a decoder side for joint picture decoding.

The coder may package an original bitstream and a detail bitstream of the same video frame in a video as bitstream data, compress the bitstream data of each of the video frames into a compressed bitstream, and transmit the compressed bitstream to the decoder. In this way, after receiving the compressed bitstream, the decoder may perform picture reconstruction on each video frame according to the bitstream data of each video frame in the compressed bitstream, to obtain a reconstructed frame picture of each video frame, thereby implementing video playback, sharing, and the like at the decoder side. For a specific implementation process in which the decoder performs joint picture decoding according to the original bitstream and the detail bitstream of the video frame after receiving the compressed bitstream, refer to the related description of the specific implementation process of the foregoing embodiment shown in FIG. 6. Details are not described herein again.

In conclusion, in the embodiments of this application, a coder side supports screening a target pixel for which residual information is greater than a residual threshold from a video frame by using a plurality of screening policies, to determine a specified region in the video frame. The plurality of screening policies can better satisfy coding requirements of coding users, and are applied to different coding scenarios, thereby improving coding experience of the coding users. In addition, at the coder side, additional coding/secondary coding is performed only on pixels within the to-be-detail-enhanced specified region. Without causing a large waste of resources, details can be enhanced, thereby significantly improving coding quality and efficiency. Correspondingly, in a process where a decoder side restores the entire video frame by using an original bitstream, detail enhancement is performed on the to-be-detail-enhanced specified region in the restored video frame by using a detail bitstream, thereby effectively improving the reconstruction quality of the pixels within the specified region lost in the coding process of the video frame, reducing precision losses caused by a prediction residual and quantization in a video coding process, and improving coding/decoding efficiency.

FIG. 12 shows a schematic structural diagram of a decoding apparatus according to an exemplary embodiment of this application. The decoding apparatus may be configured to perform some or all operations in the method embodiment shown in FIG. 6. Referring to FIG. 12, the apparatus includes the following units:
an obtaining unit 1201, configured to obtain bitstream data of a video frame, the bitstream data including an original bitstream and a detail bitstream of the video frame, the original bitstream being obtained by coding the video frame, the detail bitstream being obtained by coding a specified region in the video frame, and the specified region referring to a to-be-detail-enhanced region in the video frame; and
a processing unit 1202, configured to perform picture reconstruction processing on the detail bitstream, to obtain a reconstructed detail picture of the video frame, the reconstructed detail picture including reconstructed pixel information of pixels within the specified region.

The processing unit 1202 is further configured to decode the original bitstream, to obtain a reconstructed original picture of the video frame.

The processing unit 1202 is further configured to perform detail enhancement processing on a specified region in the reconstructed original picture according to the reconstructed detail picture, to obtain a reconstructed frame picture of the video frame.

In an implementation, when performing picture reconstruction processing on the detail bitstream, to obtain a reconstructed detail picture of the video frame, the processing unit 1202 is specifically configured to:
decode the detail bitstream, to obtain residual information of the pixels within the specified region in the reconstructed detail picture;
obtain coding mode information;
predict the pixels within the specified region according to the coding mode information, to obtain prediction information of the pixels within the specified region in the reconstructed detail picture; and
obtain the reconstructed detail picture of the video frame based on the residual information and the prediction information of the pixels within the specified region.

In an implementation, the detail bitstream includes an identifier, the identifier is configured for indicating a position of the specified region in the video frame, and when decoding the detail bitstream, to obtain residual information of the pixels within the specified region in the reconstructed detail picture, the processing unit 1202 is specifically configured to:
decode the detail bitstream to obtain the identifier; and
decode the pixels within the specified region according to the position indicated by the identifier, to obtain the residual information of the pixels within the specified region in the reconstructed detail picture.

In an implementation, the pixels in the reconstructed detail picture are in a one-to-one correspondence with pixels in the reconstructed original picture, and when performing detail enhancement processing on the specified region in the reconstructed original picture according to the reconstructed detail picture, to obtain a reconstructed frame picture of the video frame, the processing unit 1202 is specifically configured to: superimpose reconstructed pixel information of the pixels within the specified region in the reconstructed detail picture onto reconstructed pixel information of the corresponding pixels within the specified region in the reconstructed original picture; and reserve reconstructed pixel information of non-superimposed pixels in the reconstructed original picture.

According to an embodiment of this application, the units in the decoding apparatus shown in FIG. 12 may be separately or all combined into one or several other units, or one (or some) of the units may be further split into a plurality of units having smaller functions. In this way, the same operations may be implemented without affecting implementation of the technical effects of the embodiments of this application. The foregoing units are divided based on logical functions. During actual application, a function of one unit may alternatively be implemented by a plurality of units, or functions of a plurality of units are implemented by one unit. In other embodiments of this application, the decoding apparatus may also include other units. During actual application, the functions may be cooperatively implemented by other units and may be cooperatively implemented by a plurality of units. According to another embodiment of this application, the decoding apparatus as shown in FIG. 12 may be constructed, and the decoding method according to the embodiments of this application may be implemented, by running a computer program (including program code) that can perform the operations involved in the corresponding method shown in FIG. 6 on a general-purpose computing device such as a computer including a central processing unit (CPU), a random access memory (RAM), a read-only memory (ROM), and other processing elements and storage elements. The foregoing computer program may be recorded in, for example, a non-transitory computer-readable recording medium, and may be loaded into the foregoing computing device by using the computer-readable recording medium, and run therein.

Based on the same inventive concept, a principle and beneficial effects of solving a problem by the decoding apparatus provided in the embodiments of this application are similar to a principle and beneficial effects of solving the problem according to the decoding method in the method embodiments of this application. Refer to the principle and the beneficial effects of implementation of the method. For brief of description, details are not described herein again.

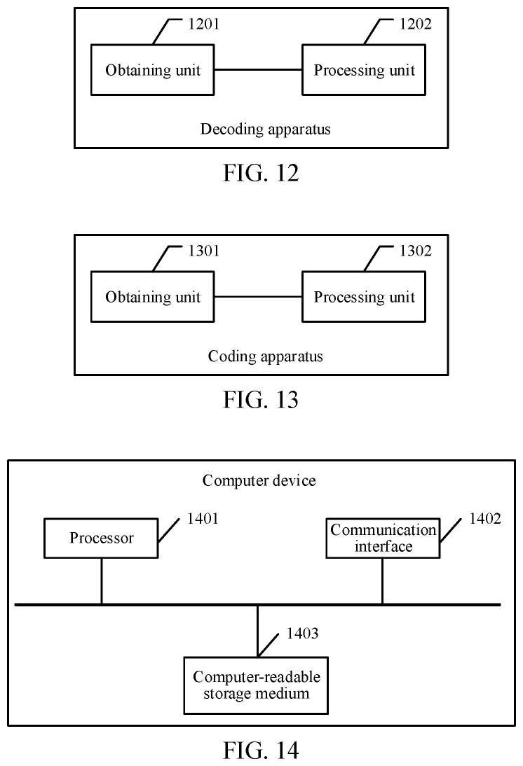

FIG. 13 shows a schematic structural diagram of a coding apparatus according to an exemplary embodiment of this application. The coding apparatus may be configured to perform some or all operations in the method embodiment shown in FIG. 8. Referring to FIG. 13, the apparatus includes the following units:
an obtaining unit 1301, configured to obtain a to-be-coded video frame, and coding the video frame, to obtain an original bitstream of the video frame; and
a processing unit 1302, configured to determine a specified region in the video frame, to obtain a detail picture of the video frame, the specified region referring to a to-be-detail-enhanced region in the video frame.

The processing unit 1302 is further configured to code the detail picture, to obtain a detail bitstream of the video frame.

The processing unit 1302 is further configured to transmit the original bitstream and the detail bitstream of the video frame to a decoder side for joint picture decoding.

In an implementation, when determining a specified region in the video frame, to obtain a detail picture of the video frame, the processing unit 1302 is specifically configured to:
obtain residual information of each pixel in the video frame, the residual information of the pixel being obtained by performing predictive coding on the pixel, and the residual information of the pixel being configured for representing a difference between original pixel information and prediction information of the pixel;
determine, from the video frame, a target pixel for which the residual information satisfies a residual condition; and
identify a specified region in the video frame according to a position of the target pixel in the video frame, to obtain a detail picture of the video frame.

In an implementation, the video frame corresponds to a residual threshold, and when determining, from the video frame, a target pixel for which the residual information satisfies a residual condition, the processing unit 1302 is specifically configured to:
compare the residual information of each pixel in the video frame with the residual threshold, to obtain a residual comparison result of each pixel, the residual comparison result being configured for indicating a magnitude relationship between the residual information of the pixel and the residual threshold; and
determine, from the video frame based on the residual comparison result of each pixel, a pixel for which the residual information is greater than the residual threshold, the pixel for which the residual information is greater than the residual threshold being used as the target pixel.

In an implementation, when determining, from the video frame, a target pixel for which the residual information satisfies a residual condition, the processing unit 1302 is specifically configured to:
obtain N luminance intervals arranged in an ascending order of luminance values, and a residual threshold matching each luminance interval, N being a positive integer;
obtain a luminance value of each pixel in the video frame, and determine a target luminance interval to which the luminance value of each pixel belongs; and
compare residual information of each pixel in the video frame with a residual threshold matching the target luminance interval, and determine a pixel for which the residual information is greater than the corresponding residual threshold as the target pixel.

In an implementation, when determining a target luminance interval to which the luminance value of each pixel belongs, the processing unit 1302 is specifically configured to:
compare the luminance value of each pixel in the video frame with luminance values included in the N luminance intervals, and determine the target luminance interval to which the luminance value of each pixel belongs.

In an implementation, when determining a target luminance interval to which the luminance value of each pixel belongs, the processing unit 1302 is specifically configured to:
obtain an average luminance value of a region adjacent to each pixel in the video frame, the average luminance value being obtained by performing an averaging operation on luminance values of all pixels within the region adjacent to the pixel; and
compare the average luminance value of the region adjacent to each pixel in the video frame with the luminance values included in the N luminance intervals, and determine a target luminance interval to which the average luminance value of the region adjacent to each pixel belongs, the target luminance interval to which the average luminance value of the region adjacent to the pixel belongs being used as the target luminance interval to which the luminance value of the pixel belongs.

In an implementation, when determining, from the video frame, a target pixel for which the residual information satisfies a residual condition, the processing unit 1302 is specifically configured to:
obtain M value intervals arranged in an ascending order of values, and a residual threshold matching each value interval, a maximum value in the M value intervals being a sum of Q first preset values, a minimum value being a sum of Q second preset values, and M and Q being positive integers;
obtain residual information of each pixel in Q pixels adjacent to any pixel in the video frame, mark non-zero residual information among the residual information of the Q pixels as a first preset value, and mark zero residual information among the residual information of the Q pixels as a second preset value;
perform an addition operation on the marked first preset values in the Q pixels, to obtain a preset value addition result;
determine, based on the preset value addition result, a target value interval to which any pixel belongs; and
determine any pixel as the target pixel if the residual information of any pixel is greater than a residual threshold matching the target value interval.

In an implementation, when determining, from the video frame, a target pixel for which the residual information satisfies a residual condition, the processing unit 1302 is specifically configured to:
perform picture reconstruction on the original bitstream, to obtain a reconstructed picture corresponding to the video frame;
perform picture enhancement processing on the reconstructed picture to obtain an enhanced reconstructed picture; and
perform a difference operation on the enhanced reconstructed picture and the reconstructed picture, to obtain a difference picture, the difference picture including a target pixel for which the residual information satisfies a residual condition.

In an implementation, when identifying a specified region in the video frame according to a position of the target pixel in the video frame, to obtain a detail picture of the video frame, the processing unit 1302 is specifically configured to:
perform region partitioning on the video frame, to obtain at least two first regions corresponding to the video frame; and
identify, if any first region in the at least two first region includes the target pixel, the first region as a specified region in the video frame.

In an implementation, when identifying any first region as a specified region in the video frame, the processing unit 1302 is specifically configured to:
perform region partitioning on any first region including the target pixel, to obtain at least two second regions corresponding to the first region, a region area size of the second region being less than a region area size of the first region; and
identify, if any second region in the at least two second region includes the target pixel, the second region as a specified region in the video frame.

According to an embodiment of this application, the units in the coding apparatus shown in FIG. 13 may be separately or all combined into one or several other units, or one (or some) of the units may be further split into a plurality of units having smaller functions. In this way, the same operations may be implemented without affecting implementation of the technical effects of the embodiments of this application. The foregoing units are divided based on logical functions. During actual application, a function of one unit may alternatively be implemented by a plurality of units, or functions of a plurality of units are implemented by one unit. In other embodiments of this application, the coding apparatus may also include other units. During actual application, the functions may be cooperatively implemented by other units and may be cooperatively implemented by a plurality of units. According to another embodiment of this application, the coding apparatus as shown in FIG. 13 may be constructed, and the coding method according to the embodiments of this application may be implemented, by running a computer program (including program code) that can perform the operations involved in the corresponding method shown in FIG. 8 on a general-purpose computing device such as a computer including a CPU, a RAM, a ROM, and other processing elements and storage elements. The foregoing computer program may be recorded in, for example, a computer-readable recording medium, and may be loaded into the foregoing computing device by using the computer-readable recording medium, and run therein.

Based on the same inventive concept, a principle and beneficial effects of solving a problem by the coding apparatus provided in the embodiments of this application are similar to a principle and beneficial effects of solving the problem according to the coding method in the method embodiments of this application. Refer to the principle and the beneficial effects of implementation of the method. For brief of description, details are not described herein again.

FIG. 14 shows a structural block diagram of a computer device according to an exemplary embodiment of this application. Referring to FIG. 14, the computer device includes a processor 1401, a communication interface 1402, and a computer-readable storage medium 1403. The processor 1401, the communication interface 1402, and the computer-readable storage medium 1403 may be connected through a bus or in another manner. The communication interface 1402 is configured to receive and transmit data. The computer-readable storage medium 1403 may be stored in a memory of the computer device. The computer-readable storage medium 1403 is configured to store a computer program. The computer program includes computer instructions. The processor 1401 is configured to execute the program instructions stored in the computer-readable storage medium 1403. The processor 1401 (which is also referred to as a CPU) is a computing core and a control core of a computer device, and is configured to implement one or more instructions, and is specifically configured to load and execute the one or more instructions to implement a corresponding method procedure or a corresponding function.

Embodiments of this application further provide a computer-readable storage medium (memory). The computer-readable storage medium is a memory device in a computer device, and is configured to store a program and data. The computer-readable storage medium herein may include a built-in storage medium in the computer device, or may certainly include an extended storage medium supported by the computer device. The computer-readable storage medium provides storage space, and a processing system of the computer device is stored in the storage space. In addition, one or more instructions adapted to be loaded and executed by the processor 1401 are further stored in the storage space, and the instructions may be one or more computer instructions (including program code). The computer-readable storage medium herein may be a high-speed RAM memory, or may be a non-volatile memory, for example, at least one magnetic disk memory. In some embodiments, the computer-readable storage medium may alternatively be at least one computer-readable storage medium located away from the processor.

In an embodiment, the computer-readable storage medium has one or more instructions stored therein. The processor 1401 loads and executes the one or more instructions stored in the computer-readable storage medium, to implement the corresponding operations in the foregoing embodiments of the decoding method. In a specific implementation, the one or more instructions in the computer-readable storage medium are loaded and executed by the processor 1401 to perform the decoding method and the coding method described above.

Based on the same inventive concept, a principle and beneficial effects of solving a problem by the computer device provided in the embodiments of this application are similar to a principle and beneficial effects of solving the problem according to the decoding method and the coding method provided in the method embodiments of this application. Refer to the principle and the beneficial effects of implementation of the method. For brief of description, details are not described herein again.

Embodiments of this application further provide a computer program product or computer program. The computer program product or computer program includes computer instructions. The computer instructions are stored in a computer-readable storage medium. A processor of a blockchain node device reads the computer instructions from the computer-readable storage medium. The processor executes the computer instructions, to cause the computer device to perform the foregoing decoding method and coding method.

A person of ordinary skill in the art may be aware that, in combination with the examples described in the embodiments disclosed in this application, units and algorithm operations may be implemented by electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this application.

All or some of the foregoing embodiments may be implemented by using software, hardware, firmware, or any combination thereof. When the software is used for implementation, implementation may be entirely or partially performed in a form of a computer program product. The computer program product includes one or more computer instructions. When computer program instructions are loaded and executed on a computer, the procedures or functions according to the embodiments of this application are all or partially generated. The computer may be a general-purpose computer, a dedicated computer, a computer network, or another programmable device. The computer instructions may be stored in the computer-readable storage medium or transmitted through the computer-readable storage medium. The computer instructions may be transmitted from a website, computer, server, or data center to another website, computer, server, or data center in a wired (e.g., a coaxial cable, an optical fiber, or a digital subscriber line (DSL)) or wireless (e.g., infrared, radio, or microwave) manner. The computer-readable storage medium may be any usable medium accessible by the computer, or a data processing device, for example, a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application is required to fall within the protection scope of this application. Therefore, the protection scope of this application is required to be subject to the protection scope of the claims.

What is claimed is:

1. A coding method performed by a computer device, the method comprising:
coding a video frame, to obtain an original bitstream of the video frame;
performing predictive coding on each pixel in the video frame to obtain residual information of the pixel, and the residual information of the pixel being configured for representing a difference between original pixel information and prediction information of the pixel;
determining, from the video frame, a target pixel whose residual information satisfies a residual condition;
identifying a specified region in the video frame according to a position of the target pixel in the video frame, to obtain a detail picture of the video frame;
coding the detail picture, to obtain a detail bitstream of the video frame; and
transmitting the original bitstream and the detail bitstream of the video frame to a decoder side for joint picture decoding.

2. The method according to claim 1, wherein the determining, from the video frame, a target pixel whose residual information satisfies a residual condition comprises:
comparing the residual information of each pixel in the video frame with a residual threshold, to obtain a residual comparison result of each pixel; and
determining, from the video frame based on the residual comparison result of each pixel, a pixel whose residual information is greater than the residual threshold as the target pixel.

3. The method according to claim 1, wherein the determining, from the video frame, a target pixel whose residual information satisfies a residual condition comprises:
obtaining N luminance intervals arranged in an ascending order of luminance values, and a residual threshold matching each luminance interval, N being a positive integer;
obtaining a luminance value of each pixel in the video frame, and determining a target luminance interval to which the luminance value of each pixel belongs; and
comparing residual information of each pixel in the video frame with a residual threshold matching the target luminance interval, and determining a pixel for which the residual information is greater than the corresponding residual threshold as the target pixel.

4. The method according to claim 3, wherein the determining a target luminance interval to which the luminance value of each pixel belongs comprises:
comparing the luminance value of each pixel in the video frame with luminance values comprised in the N luminance intervals, and determining the target luminance interval to which the luminance value of each pixel belongs.

5. The method according to claim 3, wherein the determining a target luminance interval to which the luminance value of each pixel belongs comprises:
obtaining an average luminance value of a region adjacent to each pixel in the video frame, the average luminance value being obtained by performing an averaging operation on luminance values of all pixels within the region adjacent to the pixel; and
comparing the average luminance value of the region adjacent to each pixel in the video frame with the luminance values comprised in the N luminance intervals, and determining a target luminance interval to which the average luminance value of the region adjacent to each pixel belongs, the target luminance interval to which the average luminance value of the region adjacent to the pixel belongs being used as the target luminance interval to which the luminance value of the pixel belongs.

6. The method according to claim 1, wherein the determining, from the video frame, a target pixel whose residual information satisfies a residual condition comprises:
obtaining M value intervals arranged in an ascending order of values, and a residual threshold matching each value interval, a maximum value in the M value intervals being a sum of Q first preset values, a minimum value being a sum of Q second preset values, and M and Q being positive integers;
obtaining residual information of each pixel in Q pixels adjacent to any pixel in the video frame, marking non-zero residual information among the residual information of the Q pixels as a first preset value, and marking zero residual information among the residual information of the Q pixels as a second preset value;
performing an addition operation on the marked first preset values in the Q pixels, to obtain a preset value addition result;
determining, based on the preset value addition result, a target value interval to which any pixel belongs; and
determining any pixel as the target pixel if the residual information of any pixel is greater than a residual threshold matching the target value interval.

7. The method according to claim 1, wherein the determining, from the video frame, a target pixel whose residual information satisfies a residual condition comprises:
performing picture reconstruction on the original bitstream, to obtain a reconstructed picture corresponding to the video frame;
performing picture enhancement processing on the reconstructed picture to obtain an enhanced reconstructed picture; and
performing a difference operation on the enhanced reconstructed picture and the reconstructed picture, to obtain a difference picture, the difference picture comprising a target pixel whose residual information satisfies a residual condition.

8. The method according to claim 1, wherein the identifying a specified region in the video frame according to a position of the target pixel in the video frame, to obtain a detail picture of the video frame comprises:
performing region partitioning on the video frame, to obtain at least two first regions corresponding to the video frame; and
identifying one of the at least two first region that comprises the target pixel as the specified region in the video frame.

9. The method according to claim 8, wherein the identifying one of the at least two first region that comprises the target pixel as a specified region in the video frame comprises:
performing region partitioning on any first region comprising the target pixel, to obtain at least two second regions corresponding to the first region, a region area size of the second region being less than a region area size of the first region; and
identifying one of the at least two second region that comprises the target pixel as the specified region in the video frame.

10. A computer device, comprising:
a processor adapted to execute a computer program; and
a computer-readable storage medium, the computer-readable storage medium having a computer program stored therein, and the computer program, when executed by the processor, causing the computer device to implement a coding method including:
coding a video frame, to obtain an original bitstream of the video frame;
performing predictive coding on each pixel in the video frame to obtain residual information of the pixel, and the residual information of the pixel being configured for representing a difference between original pixel information and prediction information of the pixel;
determining, from the video frame, a target pixel whose residual information satisfies a residual condition;
identifying a specified region in the video frame according to a position of the target pixel in the video frame, to obtain a detail picture of the video frame;
coding the detail picture, to obtain a detail bitstream of the video frame; and
transmitting the original bitstream and the detail bitstream of the video frame to a decoder side for joint picture decoding.

11. The computer device according to claim 10, wherein the determining, from the video frame, a target pixel whose residual information satisfies a residual condition comprises:
comparing the residual information of each pixel in the video frame with a residual threshold, to obtain a residual comparison result of each pixel; and
determining, from the video frame based on the residual comparison result of each pixel, a pixel whose residual information is greater than the residual threshold as the target pixel.

12. The computer device according to claim 10, wherein the determining, from the video frame, a target pixel whose residual information satisfies a residual condition comprises:
obtaining N luminance intervals arranged in an ascending order of luminance values, and a residual threshold matching each luminance interval, N being a positive integer;
obtaining a luminance value of each pixel in the video frame, and determining a target luminance interval to which the luminance value of each pixel belongs; and
comparing residual information of each pixel in the video frame with a residual threshold matching the target luminance interval, and determining a pixel for which the residual information is greater than the corresponding residual threshold as the target pixel.

13. The computer device according to claim 12, wherein the determining a target luminance interval to which the luminance value of each pixel belongs comprises:
comparing the luminance value of each pixel in the video frame with luminance values comprised in the N luminance intervals, and determining the target luminance interval to which the luminance value of each pixel belongs.

14. The computer device according to claim 12, wherein the determining a target luminance interval to which the luminance value of each pixel belongs comprises:
obtaining an average luminance value of a region adjacent to each pixel in the video frame, the average luminance value being obtained by performing an averaging operation on luminance values of all pixels within the region adjacent to the pixel; and
comparing the average luminance value of the region adjacent to each pixel in the video frame with the luminance values comprised in the N luminance intervals, and determining a target luminance interval to which the average luminance value of the region adjacent to each pixel belongs, the target luminance interval to which the average luminance value of the region adjacent to the pixel belongs being used as the target luminance interval to which the luminance value of the pixel belongs.

15. The computer device according to claim 10, wherein the determining, from the video frame, a target pixel whose residual information satisfies a residual condition comprises:
obtaining M value intervals arranged in an ascending order of values, and a residual threshold matching each value interval, a maximum value in the M value intervals being a sum of Q first preset values, a minimum value being a sum of Q second preset values, and M and Q being positive integers;
obtaining residual information of each pixel in Q pixels adjacent to any pixel in the video frame, marking non-zero residual information among the residual information of the Q pixels as a first preset value, and marking zero residual information among the residual information of the Q pixels as a second preset value;
performing an addition operation on the marked first preset values in the Q pixels, to obtain a preset value addition result;
determining, based on the preset value addition result, a target value interval to which any pixel belongs; and
determining any pixel as the target pixel if the residual information of any pixel is greater than a residual threshold matching the target value interval.

16. The computer device according to claim 10, wherein the determining, from the video frame, a target pixel whose residual information satisfies a residual condition comprises:
performing picture reconstruction on the original bitstream, to obtain a reconstructed picture corresponding to the video frame;
performing picture enhancement processing on the reconstructed picture to obtain an enhanced reconstructed picture; and
performing a difference operation on the enhanced reconstructed picture and the reconstructed picture, to obtain a difference picture, the difference picture comprising a target pixel whose residual information satisfies a residual condition.

17. The computer device according to claim 10, wherein the identifying a specified region in the video frame according to a position of the target pixel in the video frame, to obtain a detail picture of the video frame comprises:
performing region partitioning on the video frame, to obtain at least two first regions corresponding to the video frame; and
identifying one of the at least two first region that comprises the target pixel as the specified region in the video frame.

18. The computer device according to claim 17, wherein the identifying one of the at least two first region that comprises the target pixel as a specified region in the video frame comprises:
performing region partitioning on any first region comprising the target pixel, to obtain at least two second regions corresponding to the first region, a region area size of the second region being less than a region area size of the first region; and
identifying one of the at least two second region that comprises the target pixel as the specified region in the video frame.

19. A non-transitory computer-readable storage medium having a computer program stored therein, and the computer program, when executed by a processor of a computer device, causing the computer device to perform a coding method including:
coding a video frame, to obtain an original bitstream of the video frame;
performing predictive coding on each pixel in the video frame to obtain residual information of the pixel, and the residual information of the pixel being configured for representing a difference between original pixel information and prediction information of the pixel;
determining, from the video frame, a target pixel whose residual information satisfies a residual condition;
identifying a specified region in the video frame according to a position of the target pixel in the video frame, to obtain a detail picture of the video frame;
coding the detail picture, to obtain a detail bitstream of the video frame; and
transmitting the original bitstream and the detail bitstream of the video frame to a decoder side for joint picture decoding.

20. The non-transitory computer-readable storage medium according to claim 19, wherein the determining, from the video frame, a target pixel whose residual information satisfies a residual condition comprises:
obtaining N luminance intervals arranged in an ascending order of luminance values, and a residual threshold matching each luminance interval, N being a positive integer;
obtaining a luminance value of each pixel in the video frame, and determining a target luminance interval to which the luminance value of each pixel belongs; and
comparing residual information of each pixel in the video frame with a residual threshold matching the target luminance interval, and determining a pixel for which the residual information is greater than the corresponding residual threshold as the target pixel.
